(19) United States
(12) Patent Application Publication
(10) Pub. No.: US 2025/0179263 A1
(43) Pub. Date: Jun. 5, 2025

(54) (POLY)ESTER AND (POLY)AMIDE COMPOSITIONS, METHOD FOR MODIFYING (POLY)ESTERS OR (POLY)AMIDES AND CATALYST THEREFOR

(71) Applicants: FRIEDRICH-SCHILLER-UNIVERSITÄT JENA, Jena (DE); CENTRO DE INVESTIGACION EN QUIMICA APLICADA, Saltillo (MX)

(72) Inventors: Carlos GUERRERO SANCHEZ, Leipzig (DE); Victor Daniel LECHUGA ISLAS, Actopan (MX); Ramiro GUERRERO SANTOS, Saltillo (MX); Ulrich S. SCHUBERT, Jena (DE)

(21) Appl. No.: 18/840,724

(22) PCT Filed: Feb. 23, 2022
(86) PCT No.: PCT/EP2022/000018

§ 371 Date: Aug. 22, 2024

(51) Int. Cl. C08J 11/28; C08F 12/28; C08F 297/02; C08L 67/02

(52) U.S. Cl. CPC C08J 11/28; C08F 12/28; C08F 297/026; C08L 67/02; C08J 2367/02; C08J 2425/18; C08J 2453/00

(57) ABSTRACT

Disclosed are transesterification and transamidation reactions and depolymerization reactions of polyesters and polyamides using catalysts comprising a structural unit of formula (I). Therein, o is a positive integer of at least 1, R³ is selected from the group of hydrogen, halogen, or optionally substituted C₁-C₁₈ alkyl, Z is a group-BG-Cat⁺ M, BG is a covalent bond or a divalent bridge group, Cat⁺ is a selected cationic residue, preferably an imidazolinium group, covalently attached to BG, M is an i-times charged anion Anⁱ⁻ for charge-compensation, and i is an integer from 1 to 4. The invention provides a method for (trans)esterification or (trans)amidation reactions to produce biodiesel, to depolymerize polyesters/polyamides using reusable polymer catalysts, wherein the polymer catalysts not only provide a homogeneous and high catalytic activity for degradation or transformation reactions but allow also a heterogeneous separation of the catalysts and/or impurities, such as additives, colorants (pigments or dyes), from the reaction products.

### FIELD OF INVENTION/TECHNICAL FIELD

The present invention is in the field of a method of catalytically modifying (poly)esters or (poly)amides, for example by degradation into oligomers and/or monomers in a solvent, and an improved catalyst being capable of modifying (poly)esters or (poly)amides. The compositions, methods and catalysts provide a high selectivity and a high conversion ratio, for instance but not limited to, the catalytic production of biodiesel or the catalytic chemical recycling of (poly)ester or (poly)amide materials, to produce high purity reaction products. The invention further relates to an improved method of depolymerizing post-consumer polyesters or polyamides, in catalyzed homogeneous depolymerization reactions, wherein the catalysts can be used in a plurality of compositions and wherein the catalysts have structures for tailoring catalytic activity, catalyst recovery, and separation of impurities to yield depolymerization products of high purity.

### BACKGROUND OF THE INVENTION

Crude fats and oils extracted from animal or vegetable sources (containing mainly triglycerides) are the mainly used raw biomaterials transformed into biofuels. Although this transformation is based on relatively simple chemical reactions (e.g., thermocatalytic cracking to produce diesel-like procuts by (trans)esterification of triglycerides to yield biodiesel), they have several drawbacks related to energy, water triglycerides to yield biodiesel), they have several drawbacks related to energy, water consumption and catalysts reusability. Therefore, more efficient catalytic processes for these transformations are needed in the art to make such fuels more accessible.

Apart from the reduction in the use of natural resources, handling of waste materials is also a factor with significant high impact on environmental conservation practices. Therefore, the development of cost-effective, efficient, and sustainable recycling methods for commodity polyester or polyamide materials is highly desirable, which can lead to a significant decrease in the consumption of fossil-based sources and the accumulation of waste in the environment.

Several chemical recycling methods have been developed to achieve material upcycling. Some of the most recognized chemical mechanisms are based on esterification and transesterification reactions to produce value-added materials. With respect to the upcycling of vegetable oils and animal fats, the (trans)-esterification procedure to produce biodiesel is regarded as a renewable, non-toxic, and ecofriendly source of fuel. This process generally requires the presence of alkaline catalysts. Regarding post-consumer polyester recycling, current methods include mechanical processes based on exhaustive multistep procedures (see e.g., Awaja, D. Pavel, Recycling of PET, Eur. Polym. J. 41 (2005) 1453-1477, or P. Subramanian, Resour. Conserv. Recycl. 28 (2000) 253-263). Other polyester recycling methods use chemical methods based on transesterification reactions (e.g., methanolysis and glycolysis). Mechanical recycling involves melt-processing and remolding of post-consumer polyesters, and it is already used in large scale, mainly for post-consumer polyethylene terephthalate (PET). However, without intensive sorting and cleaning of the post-consumer material, the recycled product frequently lacks desirable mechanical (e.g., intrinsic viscosity) and optical properties (because of dye contaminants). In contrast, the chemical recycling of polyesters can yield high quality recycled material via the degradation of polyester chains all the way back to their oligomer and/or monomer units (i.e., depolymerization). Therefore, the recovered monomer is used as a feedstock to obtain new polymers in circular, more sustainable, and potentially more economic processes (see e.g., J. M. Harris, Basic principles of sustainable development, in: R. Seidler, K. Bawa (Eds.), Dimens. Sustainable Dev., Islanf Press, 2000: pp. 21-41).

With the increasing emphasis in developing sustainable methods, in the last years, ionic liquids (ILs) have raised as promising catalysts and solvents to replace common reactants in conventional organic reactions. ILs have been successfully implemented in polyesters depolymerization, particularly in PET-waste materials, using moderate conditions (see H. Wang, Z. Li, Y. Liu, X. Zhang and S. Zhang, Green Chem., 2009, 11, 1568). Optimized catalytic systems are based on 1-butyl-3-methylimidazolium ([Bmim]ZnCl₃) after 5-hour reaction at 180° C. (see Q. F. Yue, H. G. Yang, M. L. Zhang and X. F. Bai, Adv. Mater. Sci. Eng., 2014, 2014, 1-6). The development of polyester glycolysis catalyzed by ILs is a promising system to develop sustainable recycling technologies. However, the catalyst separation, after the depolymerization, remains as a challenge. Furthermore, the proposed depolymerization systems do not deal with the problem that conveys the impurities from PET-waste; namely, the effective separation of adhesives, additives, colorants or dyes incorporated in commercial PET formulations.

The implementation of functionalized ILs, with the addition of hydrophobic functionalities or magnetic particles, represents a promising method to improve catalyst recovery process. WO 002017/111602 A1 discloses a method of degrading a polymer material, such as a polyester or polyamide, in a degradation reaction catalysed by a catalyst complex in solid form, wherein a carrier liquid acts as a reactant in the degradation reaction, which catalyst complex comprises magnetic particles and bonded thereto a plurality of catalytic groups comprising a bridging moiety and a catalyst entity, wherein the catalyst entity comprises a positively charged aromatic heterocycle moiety, and a negatively charged moiety for balancing the positively charged aromatic moiety. However, ILs functionalized with magnetic particles showed a decrement of catalytic activity under moderate glycolysis conditions (see A. M. Al-Sabagh, F. Z. Yehia, G. Eshaq and A. E. ElMetwally, Ind. Eng. Chem. Res., 2015, 54, 12474-12481).

Current main drawbacks of chemical recycling methods include the difficulty of removing corrosive, toxic, and/or unrecyclable catalysts and the intrinsic impurities and/or additives found in post-consumer polyesters or polyamides from the final product (i.e., monomers or oligomers). This factor significantly limits the applicability of chemical methods at an industrial scale. Another drawback of chemical recycling processes is that current methodologies are inefficient for recycling post-consumer materials of variable grades and/or colorations. In the case of biodiesel production, large feedstocks of oils and fats cannot be converted to biodiesel due to the high content of free fatty acids, humidity, among other impurities. Thus, rendering ineffective and economically unviable processes that need additional steps for (i) the separation of catalyst and impurities and (ii) purification of products. A variety of homogeneous and heterogeneous catalytic (trans)esterification methodologies have been proposed to improve the catalytic performance and/or separation or recovery of catalytic systems and/or impurities. Until now, there are only few catalytic developments able to simultaneously address both above mentioned needs (i.e., reutilization of catalysts and separation of impurities) while keeping a viable (trans)esterification or depolymerization performance with high conversion and high selectivity of products.

Thus, efficient and adaptable (trans)esterification or (trans)amidation methodologies comprising functional or multitasking catalysts with an adequate balance of catalytic activity, separability, and reusability are required in the art to develop effective, economically viable, and industrially applicable chemical recycling processes of post-consumer materials (e.g., oils, fats, polyesters, polyamides) of diverse grades and/or colorations.

### SUMMARY OF THE INVENTION

In a first aspect, the invention relates to a composition comprising a (poly)ester or a (poly)amide and a selected catalyst for degrading or transforming said (poly)ester or (poly)amide.

In a second aspect, the invention relates to a method of degrading or of transforming a (poly)ester or a (poly)amide using said composition.

In a third aspect, the invention relates to degradation or transformation catalysts for (poly)esters and (poly)amides, said catalysts having improved catalytic activity.

In a fourth aspect, the invention relates to degradation or transformation catalysts for (poly)esters and (poly)amides, said catalysts being copolymers and showing improved separation of the catalyst from the reaction products of the decomposition or transformation reaction.

In a fifth aspect, the invention relates to a method of manufacturing degradation or transformation catalysts for (poly)esters and (poly)amides.

It is therefore an object of the invention, to provide an improved degradation or transformation method for polyesters and polyamides and a composition of matter used in such method.

It is another object of the invention, to provide improved catalysts for degradation or transformation reactions of (poly)esters and (poly)amides.

The invention provides a method for (trans)esterification or (trans)amidation reactions to produce biodiesel, to depolymerize polyesters and/or polyamides using reusable polymer catalysts, which do not only provide a homogeneous and high catalytic activity for degradation or transformation reactions but allow also a heterogeneous separation of the catalysts and/or impurities, such as additives, colorants (pigments or dyes), from the (trans)esterification or (trans)amidation reaction products.

### BRIEF DESCRIPTION OF THE DRAWINGS

FIG. 1 shows examples of production of P[WₘYₙZₒM] through polymerization of an ionic monomer [BVSI]CI and anion exchange with metallic salts (Me_{q}Clᵣ).

FIG. 2 shows the 1H NMR spectrum of a sample of catalyst P[WₘYₙZₙCl] (sample C4).

FIG. 3A) shows ¹H NMR Spectra, B) Raman spectra, and C) TGA curves of P[WₘYₙZₒCl] (B1) and its anion exchanged P[WₘYₙZₒZn_{q}Clᵣ] derivatives. D) DSC curves of P[WₘYₙZₒCl] (A1) and its anion exchanged P[WₘYₙZₒZn_{q}Clᵣ] derivatives.

FIG. 4A) shows representative pictures of the thermo-responsive behavior of a solution of P[WₘYₙZₒZn_{q}Clᵣ] (M2) in EG (20 mg mL⁻¹). B) Temperature and transmittance curves of a solution of P[WₘYₙZₒZn_{q}Clᵣ] (M2) in EG (20 mg mL⁻¹) as a function of time. C) Turbidity measurements of P[WₘYₙZₒZn_{q}Clᵣ] (M2) in EG solutions (10 and 20 mg mL⁻¹); solid line: heating; dotted line: cooling. D) shows plots of the dₕ (nm) as a function of temperature, recorded by DLS, of a solution of P[WₘYₙZₒZn_{q}Clᵣ] (M2) in EG (10 mg mL⁻¹).

FIG. 5 shows SEM images and particle size distributions of polymer nanoparticles casted at room temperature from solutions of M2 (10 mg mL⁻¹) in different glycol solvents: A) EG, B) glycerol, and C) 1,3-propanediol.

FIG. 6 shows the effect of P[WₘYₙZₒCl] and P[WₘYₙZₒMe_{q}Clᵣ] catalysts (precursors and metal chloride indicated, R=0.7) on PET glycolysis and selectivity of BHET. B) Effect of the molar ratio (R) of P[WₘYₙZₒZn_{q}Clᵣ] (M2 to M5, Table 8) on PET glycolysis and BHET selectivity.

FIG. 7 shows the effect of the coloration of post-consumer PET on PET conversion and BHET selectivity using P[WₘYₙZₒZn_{q}Clᵣ] (M9, Table 9) as catalyst.

FIG. 8 shows TGA (FIG. 8A) and DSC (FIG. 8B) curves of the BHET obtained from the glycolysis of a mixture composed of blue, black, green, and transparent post-consumer PET.

FIG. 9A) shows an image of the blue-colored post-consumer PET flakes used in Examples 11 and 12 and the products of depolymerization reaction using P[WₘYₙZₒZn_{q}Clᵣ] (M9, Table 9) as catalyst. BHET was obtained as a white crystalline solid (left). A yellowish polymer catalyst/EG solution was obtained after washing steps of hexane/diethyl ether (X3) to obtain an organic solution with the separated impurities/dyes/pigments. B) Reusability of the polymer catalyst in solution on the depolymerization of PET and selectivity of BHET.

### DETAILED DESCRIPTION OF THE INVENTION

Set forth below is a description of what are currently believed to be preferred embodiments of the claimed invention. Any alternates or modifications in function, purpose, or structure are intended to be covered by the claims of this application. As used in this specification and the appended claims, the singular forms “a,” “an,” and “the” include plural referents unless the context clearly dictates otherwise. The terms “comprise” and/or “comprising,” as used in this specification and the appended claims, specify the presence of the stated features, integers, steps, operations, elements, and/or components, but do not preclude the presence or addition of one or more other features, integers, steps, operations, elements, components, and/or groups thereof.

The foregoing and other features of the invention are hereinafter more described and particularly pointed out in the claims. It is to be understood that the aspects described herein are not limited to specific processes, compounds, synthetic methods, articles, devices, or uses, as such can, of course, vary. It is also to be understood that the terminology used herein is for the purpose of describing aspects only and, unless specifically defined herein, is not intended to be limiting.

In the context of the present invention a (poly)ester is to be understood as a compound possessing at least one ester unit in the molecule while a polyester is a compound possessing at least two ester units in the molecule. A (poly)amide is to be understood as a compound possessing at least one amide unit in the molecule while a polyamide is to be understood as a compound possessing at least two amide units in the molecule.

In the context of the present invention, terms “catalyst(s)” or “polymer catalyst(s)” or “functional catalyst(s)” refer to functional polymers that can be homopolymers or copolymers. (Co) polymer catalysts may be selected from the group consisting of linear, branched, hyper-branched, dendritic, cyclic, star-shaped, or similar (co) polymers. Copolymer catalysts may be selected from the group consisting of statistical copolymers, asymmetric copolymers, gradient copolymers, block copolymers, quasi-block copolymers, multiblock copolymers, grafted copolymers, alternating copolymers, or the like copolymers.

Provided is a reusable functional polymer catalyst containing Lewis acidic sites, and preferably solvophobic segments and/or solvophilic segments. Such polymer catalysts demonstrated high activity in (trans)esterification and (trans)amidation reactions that require Lewis acidic sites including, but not limited to, depolymerization of polyester or polyamide materials, via methanolysis or glycolysis, and synthesis of biodiesel from a variety of vegetal and/or animal feedstocks, via methanolysis.

The polymer catalyst characteristics are particularly effective in the depolymerization of (poly)esters or (poly)amides, the recovery of the catalyst, and the separation of impurities from post-consumer materials. The polymer catalyst is reusable in adaptable (trans)esterification and (trans)amidation procedures according to the specific requirements of the feedstocks, such as post-consumer polyester or polyamide materials of different grades and/or colorations and vegetal and/or animal feedstocks. Polymer catalysts combine the advantages of both homogeneous and heterogeneous catalysts by utilizing stimuli-responsive capabilities useful for conducting the depolymerization reaction in a homogeneous and more effective way, and to achieve the separation of the catalyst complex and/or impurities in a heterogeneous manner, controlled by external stimuli, to yield depolymerization products of high purity. According to the desired purposes, the polymer catalyst might be further reused in solution or precipitated to be reused as a catalyst or in combination with pristine polymer catalyst; thus, allowing for the production and purification of depolymerization products and catalyst recovery in the same process.

The polymer catalysts are soluble in alcohols and solvent mixtures derived thereof under (trans)esterification or (trans)amidation reaction conditions. Therefore, the catalytic sites are readily and homogeneously accessible to perform (trans)-esterification or (trans)amidation reactions. At the same time, the polymer catalysts, due to their stimuli-responsive behavior in alcohols and aqueous mixtures derived thereof, can be recovered by subjecting the solution to external stimuli, in particular, but not limited to, temperature, to precipitate the polymer catalyst and recover it via decantation or filtration for further reuse. Additionally, the polymer catalyst is readily reusable in solution to perform additional (trans)esterification, (trans)amidation or depolymerization reactions.

The invention relates to compositions comprising
A) at least one (poly)ester or (poly)amide or combinations thereof, and
B) at least one polymer comprising a structural unit of formula (I)

—(CH₂—CR³Z)ₒ— (I)
wherein
is a positive integer of at least 1, preferably an integer between 2 and 10000, more preferred an integer between 5 and 1000, and most preferred an integer between 10 and 500.
R³ is selected from the group of hydrogen, halogen, C₁-C₁₈ alkyl or C₁-C₁₈ alkyl substituted with one or more substituents independently selected from the group of hydroxy, carboxy, acyloxy, OR′, O₂CR′, and CO₂R′,
R′ is selected from the group of optionally substituted C₁-C₁₈ alkyl, optionally substituted C₂-C₁₈ alkenyl, optionally substituted aryl, substituted heterocyclyl, optionally substituted aralkyl, optionally substituted alkaryl, wherein said optional substituents are selected from the group consisting of epoxy, alkoxycarbonyl, aryloxycarbonyl, isocyanato, cyano, silyl, halo and dialkylamino,
Z is a group -BG-Cat⁺ M,
BG is a covalent bond or a divalent bridge group,
Cat⁺ is a one-time positively charged cationic residue selected from the group of one-time positively charged heterocyclic residues having one, two or three ring nitrogen atoms and optionally one ring oxygen atom, one ring sulfur atom, one ring phosphorus atom, one ring arsenic atom or one ring antimony atom, ammonium cations, phosphonium cations, arsonium cations or antimonium cations covalently attached to BG,
M is a negatively i-charged counter-ion of type Anⁱ⁻ which is selected from the group of organic or inorganic anions, wherein Anⁱ⁻ will interact with one or more cationic residues Cat⁺ for charge-compensation in polymer B), and
i is an integer from 1 to 4, preferably from 1 to 3 and most preferred from 1 to 2.

Component A) is an ester or a polyester or an amide or a polyamide or a combination thereof.

Examples of esters are esters of carboxylic acids with monovalent alcohols, such as alkyl esters of carboxylic acids.

Examples of polyesters are low molar mass compounds possessing at least two ester units in the molecule. A preferred example is a triglyceride. Polyesters of this type may be liquid or solid at room temperature (25° C.). Polyesters of this type may be preferably used for manufacturing of biodiesel.

Other examples of polyesters are high molar mass compounds which are solid at room temperature. Polyesters of this type may be preferably used for degradation reactions for transforming waste materials into valuable chemicals.

Examples of amides are amides of carboxylic acids with ammonia or with organic amines, such as amides of carboxylic acids with mono- or dialkyl amines.

Examples of polyamides are low molar mass compounds possessing at least two amide units in the molecule. A preferred example is a carboxylic acid amide with an alkylene diamine. Polyamides of this type may be liquid or solid at room temperature.

Other examples of polyamides are high molar mass compounds which are solid at room temperature. Polyamides of this type may be preferably used for degradation reactions for transforming waste materials into valuable chemicals.

In case of modification, a liquid or solid (poly)ester or (poly)amide is provided which is preferably provided in a carrier liquid C) that is a suitable reactant for the (poly)ester or (poly)amide. As such, the method is considered as a transesterification or transamidation process supported by addition of a recoverable catalyst complex. For instance, alcohols may be used as a reactant. Preferred alcohols are aliphatic, for instance alkanols. For transesterification or transamidation, the reactant is preferably an alkanol, such as methanol or ethanol.

In case of degradation, a solid polyester or polyamide is provided which is preferably provided in a carrier liquid C) that is a suitable solvent for the monomer(s). As such, the method is considered as a solid-liquid degradation process supported by addition of a recoverable catalyst complex. For instance, alcohols may be used as a solvent. Preferred alcohols are aliphatic, for instance alkanols, alkanediols and alkanetriols. For glycolysis, the solvent is preferably an alkanediol or alkanetriol, such as glycol, glycerol, propylene glycol.

The polymer to be degraded is a condensation polymer selected from the group of polyesters (including polycarbonates) and polyamides.

Preferred component A) is a (poly)ester.

Preferably the polyester is a poly carboxylic ester which is preferably selected from polyethylene terephthalate (PET), polyethylene furanoate (PEF), polybutylene terephthalate (PBT), polytrimethylene terephthalate (PTT), polyglycolic acid (PGA), polylactic acid (PLA), polycaprolactone (PCL), polyethylene adipate (PEA), polyhydroxyalkanoate (PHA), polyhydroxybutyrate (PHB), polyethylene naphthalate (PEN), poly(3-hydroxybutyrate-co-3-hydroxyvalerate) (PHBV), and a polycondensate of 4-hydroxybenzoic acid and 6-hydroxynaphthalene-2-carboxylic acid (VECTRAN).

Preferably the polyamide is a poly carboxylic amide which is preferably selected from the group of aliphatic polyamides or aromatic polyamides. Preferred aliphatic polyamides are polylactams or polyamides derived from aliphatic dicarboxylic acids and aliphatic diamines, such as the polyamides of type Nylon or polycaprolactam.

In other words, a large variety of polyesters and polyamides and copolymers derived thereof may be degraded by the present method.

Some adjustments may be necessary, e.g., in terms of catalyst used, temperature applied, solvent and pressure used. The present method is best suited for degradation using glycolysis, such as in degradation of polyesters, in particular PET and PEF. Suitably, the polymer material to be degraded is a waste polymer material, for instance from bottles or textiles. This waste material typically comprises one or more additives. Particularly the colorants therein are deemed problematic.

The additive is suitably a colorant, such as a pigment or dye. A variation of dyes and pigments used in polymer materials of the representative examples mentioned above, for instance PET, may well be known to those in the art of the manufacture of articles of those polymers, such as bottles.

Component B) is a catalyst for promoting deesterification, (trans)esterification, deamidation or (trans)amidation reactions of component A).

In a preferred embodiment component B) is a copolymer comprising recurring units of formulae (I) and (II) and optionally (III),

—(CH₂—CR¹W)ₘ— (II)

—(CH₂—CR²Y)ₙ- (III)
wherein formula (I) is as defined above,
m and n independently of one another are positive integers of at least 1, preferably an integer between 2 and 10000, more preferred an integer between 5 and 1000, and most preferred an integer between 10 and 500.
R¹ and R² independently of one another are selected from the group of hydrogen, halogen, C₁-C₁₈ alkyl or C₁-C₁₈ alkyl substituted with one or more substituents independently selected from the group of hydroxy, carboxy, acyloxy, OR′, O₂CR′, and CO₂R′,
R′ is as defined above,
W and Y independently or one another are selected from the group of hydrogen, halogen, C₁-C₁₈ alkyl, cycloalkyl, alkoxy, alkylamino, and aryl, CO₂H, CO₂R′, COR′, CN, CONH₂, CONHR′, CONR′₂, O₂CR′ and OR′; wherein R′ has the meaning defined above.

In certain embodiments, component B) comprises different polymer structures, such as homopolymers consisting of recurring structural units of formula (I), or copolymers comprising structural units of formulae (I) and (II) or of formulae (I), (II) and (III). Such copolymers are selected, for example, from the group of statistical copolymers, block copolymers, quasi-block copolymers, multiblock copolymers, grafted copolymers, alternating copolymers, asymmetric copolymers, multi-arm or star-shaped copolymers. In certain embodiments, the presence of additional solvophilic and/or solvophobic segments provides additional features to the polymer catalysts.

In a preferred embodiment component B) is a block-copolymer or a quasi-block copolymer comprising at least one block of recurring units of formula (II) and at least one block of recurring units of formula (IIIa)

[—(CH₂—CR¹W—)ₘ] (II),

[—(CH₂—CR²Y—)ₙ . . . —(CH₂—CR³Z—)ₒ] (IIIa),
wherein the two recurring units in formula (IIIa) are arranged in a statistical manner or in the form of blocks, and wherein
m, n, o, R¹, R², R³, W, Y and Z are as defined above.

Under a block-copolymer as used in this specification a copolymer is understood that comprises different blocks of recurring monomer units, such as units of formulae (I) and (II), of formulae (II) and (III) or of formulae (I), (II), and (III),

Under a quasi block-copolymer as used in this specification a copolymer is understood that is prepared in a sequential manner, e.g., by preparing a first block of one type of recurring structural units followed by a second block of another type of recurring structural units, which contain the same structural units as in the first block. One example of a quasi block-copolymer is a copolymer comprising a block of recurring structural units of formula (II) and another block comprising a combination of recurring structural units of formula (II) and containing therein statistically distributed structural units of formula (I).

If one of the residues R¹, R² and/or R³ or residues R⁴, R⁵ and/or Re defined below is alkyl, the alkyl group can be branched or unbranched. An alkyl group typically contains one to eighteen carbon atoms. Examples of alkyl groups are methyl, ethyl, n-propyl, isopropyl, n-butyl, sec-butyl, tert.-butyl, pentyl, n-hexyl, n-heptyl, 2-ethylhexyl, n-octyl, n-nonyl, n-decyl, n-undecyl or n-dodecyl. Alkyl groups with one to six carbon atoms are particularly preferred. Alkyl groups may be substituted, for example with carboxyl groups with carboxylic ester groups or with hydroxyl groups.

Most preferred groups R¹, R² and/or R³ or residues R⁴, R⁵ and/or Re defined below are hydrogen or methyl.

If one of the residues R¹, R² and/or R³ or residues R⁴, R⁵ and/or Re defined below is halogen, this shall mean a covalently bound fluorine, chlorine, bromine or iodine atom. Preferred are fluorine, chlorine or bromine, most preferred chlorine or bromine.

If BG means a divalent bridge group, it is to be understood a covalent bond or a divalent inorganic or organic residue. Examples of divalent inorganic residues are —O—, —S—, —SO—, —SO₂—, —OP(O)O— or —NH—. Examples of divalent organic residues are alkylene, cycloalkylene, arylene, aralkylene or heterocyclylene. Alkylene groups may carry heteroatoms, such as —O— or —NH—, in their chain or may carry carboxylic acid ester groups or carboxylic amide groups, such as —COO— or —CONH—, in their chain.

BG as alkylene groups can be both branched and unbranched. Alkylene groups typically contain one to one hundred carbon atoms, preferably one to ten carbon atoms. Examples of alkylene groups are: methylene, ethylene, propylene, butylene, pentylene, hexylene, heptylene, octylene, nonylene and decylene. BG as alkylene groups carrying carboxylic acid ester groups may be —COO—(CH₂)ₜ—, with t being an integer between 1 and 100. BG as alkylene groups carrying carboxylic amide groups may be —CONH—(CH₂)ₜ—, with t being an integer between 1 and 100.

BG as cycloalkylene groups typically contain five, six or seven ring carbon atoms, each of which can be substituted independently of one another. Examples of substituents are alkyl groups or two alkyl groups, which together with the ring carbons to which they are attached can form another ring. Preferred cycloalkylene group BG is cyclohexylene.

BG as arylene groups typically are cyclic aromatic groups comprising five to fourteen carbon atoms, each of which can be substituted independently of one another. Examples of arylene groups are o-phenylene, m-phenylene, p-phenylene, o-biphenylyl, m-biphenylyl, p-biphenylyl or naphthylene. Arylene groups optionally can be substituted, for example with alkyl groups or two alkyl groups, which together with the ring carbon atoms to which they are attached can form another ring. Preferred arylene group BG is phenylene.

BG as heterocyclyl groups typically are cyclic groups containing four to ten ring carbon atoms and at least one ring hetero atom, each of which can be substituted independently of one another. Examples of hetero atoms are oxygen, nitrogen, phosphorous, boron, selenium or sulfur. Examples of heterocyclyl groups are furanediyl, thiophenediyl, pyrroldiyl or imidazolediyl. Heterocyclyl groups preferably are aromatic. Heterocyclyl groups optionally can be substituted, for example with alkyl groups or two alkyl groups, which together with the ring carbon atoms to which they are attached can form another ring.

BG as aralkylene groups typically are aryl groups, to which one or two alkyl groups are covalently attached. Aralkylene groups can be covalently attached with the remainder of the molecule via their aryl residue and their alkyl residue or via two alkyl residues. The aralkylene group may be substituted at its aromatic ring, for example, with alkyl groups or with halogen atoms. Preferred aralkylene groups BG are groups —C₆H₄—(CH₂)ₚ—, wherein p is an integer between 1 and 100.

Preferably BG is a covalent bond, an alkylene group of 1-10 carbon atoms, a phenylene group, an aralkylene group —C₆H₄—(CH₂)ₚ—, wherein p is an integer between 1 and 100, or groups selected from —COO—(CH₂)ₜ— or —CONH—(CH₂)ₜ—, wherein t is an integer from 1 to 100, preferably from 1 to 10, and the carbon atom in the —COO— group or in the —CH—NH— group is attached to the polymer backbone and one carbon atom in the —(CH₂)ₚ— group is attached to Cat⁺.

Cat⁺ is preferably a selected heterocyclyl group, typically a cyclic group containing four to ten ring carbon atoms and between one and three nitrogen ring hetero atom(s). Besides nitrogen, additional ring hetero atoms may be present. Examples thereof are oxygen, sulfur, phosphorus, arsenic or antimony, preferably oxygen or sulfur. Cat⁺ heterocyclyl groups preferably are aromatic. Cat⁺ heterocyclyl groups optionally can be substituted, for example with alkyl groups or two alkyl groups, which together with the ring carbon atoms to which they are attached can form another ring.

Preferred examples of Cat⁺ are selected from monovalent quaternary ammonium residues, monovalent quaternary phosphonium residues, one-times positively charged monovalent heterocyclic groups with one to three ring nitrogen atoms and optionally one oxygen or one sulfur ring atom, said heterocyclic groups having 5 or 6 ring atoms, preferably 5 ring atoms.

More preferred Cat⁺ residues are aromatic heterocycles, very preferred pyrimidines, imidazoles, piperidines, pyrrolidine, pyridine, pyrazol, oxazol, triazol, thiazol, methimazol, benzotriazol, isoquinol and viologen-type compounds (having two coupled pyridine-ring structures). Particularly preferred group Cat⁺ is an imidazole structure, which results in an imidazolium ion.

For charge-compensation of the cationic residue Cat⁺, an anion M is present. M is a negatively charged counter-ion of the type An⁻, An²⁻, An₃₋ or An⁴⁻ where the negatively charged An⁻, An²⁻, An³⁻ or An⁴⁻ moieties relate to organic or inorganic anions including anionic salt complexes, preferably metal salt complexes having one-plus charged to five-plus charged metal ions and negatively charged counter-ions, such as those metal salt complexes described in J. Estager, J. D. Holbrey and M. Swadźba-Kwaśny, Chem. Soc. Rev., 2014, 43, 847-886. Metal ions include but are not limited to Cu⁺, Ca²⁺, Cu²⁺, Zn²⁺, Fe³⁺, Al³⁺, Zr⁴⁺ or Nb⁵⁺. Negatively charged counter-ions include but are not limited to halogenides, e.g., CI, F or Br.

Anⁱ⁻ is an i-times charged organic or inorganic anion or a mixture of such anions. The amount of anions present in the catalyst polymer is selected in a manner that the charges of Cat⁺ are compensated. As such, Anⁱ⁻ can simultaneously interact with one or more cationic residues Cat⁺ for charge-compensation of the entire polymer B).

Examples of inorganic anions Anⁱ⁻ are halogenide ions, such as fluoride, chloride, bromide or iodide, or hydroxide ions or anions of inorganic acids, such as phosphate, sulfate, nitrate, hexafluorophosphate, tetrafluoroborate, perchlorate, chlorate, hexafluoroantimonate, hexafluoroarsenate, cyanide.

Preferred inorganic anions Anⁱ⁻ are species of the type [Me_{q}Clᵣ]ⁱ⁻, as hereinafter defined, such as, but not limited to, [ZnCl₄]²⁻, [Zn₂Cl₆]²⁻, [Zn₃Cl₈]²⁻, [Zn₄Cl₁₀]²⁻, and anions selected from the group consisting of Cl⁻, Br⁻, I⁻, PF₆⁻, BF₄⁻, B(CN)₄⁻, NO₃⁻, N₃⁻, SCN⁻, NF₂S₂O₄⁻, N(CN₂)⁻, SO₄²⁻, HPO₄²⁻ and H₂PO₄⁻.

Examples of organic anions Anⁱ⁻ are anions of mono- or polyvalent carboxylic acids or of mono- or polyvalent sulfonic acids, wherein these acids may be saturated or unsaturated. Examples of anions of organic acids are acetate, formiate, trifluoro-acetate, trifluoromethanesulfonate, pentafluoroethanesulfonate, nonofluorobutane-sulfonate, butyrate, citrate, fumarate, glutarate, lactate, malate, malonate, oxalate, pyruvate or tartrate.

Preferred organic anions Anⁱ⁻ are anions selected from the group consisting of BRF₃⁻, BRR′F₂⁻, BR₄⁻, CF₃SO₃⁻, CF₃CO₂⁻, HCO₂⁻, RCO₂⁻, RNH₂CO₂⁻, N(CF₃SO₂)₂⁻, N(RSO₂)₂⁻, N(CF₂S₂O₄)⁻, RSO₃⁻, and RR′PO₄⁻, wherein R and R′ are independently selected from the group consisting of alkyl, alkenyl, alkynyl, haloalkyl, alkoxyalkyl, cycloalkyl, cycloalkylalkyl, aryl, aralkyl, heterocyclyl, heterocyclylalkyl, heteroaryl, and heteroarylalkyl.

Very preferred anions Anⁱ⁻ are anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4, preferably between 1 and 3 and most preferred 1 or 2.

Preferred anions Anⁱ⁻ are selected from the group consisting of [ZnCl₄]²⁻, [Zn₂Cl₆]²⁻, [Zn₃Cl₈]²⁻, [Zn₄Cl₁₀]²⁻, [FeCl₄]⁻, [FeCl₄]²⁻, [Fe₂Cl₇]⁻, [CoCl₄]²⁻, [CoCl₂(CoCl₄)₂]⁴⁻, [CoCl₂(CO₂Cl₄)₃]⁴⁻ and the mixtures thereof.

Some of these preferred anions Anⁱ⁻ may be prepared by reacting a salt, such as AlCl₃, AuCl₃ NbCl₅, CdCl₂, CuCl, CuCl₂, MnCl₂, FeCl₂, FeCl₃, GaCl₃ HfCl₄, CoCl₂, NiCl₂, GaCl₃, PbCl₂, SnCl₂, TiCl₄, ZnCl₂, ZrCl₄ with a halide anion, such as chloride anion, wherein an anion of formula [Me_{q}Clᵣ]ⁱ⁻ is formed.

The invention also relates to polymers comprising structural units of formula (I) and optionally of formula (II) and/or (III) and having anions [Me_{q}Halᵣ]ⁱ⁻. These polymers are especially active as catalysts in polyester or polyamide degradation or in transesterification or transamidation reactions.

In one embodiment of the invention catalyst B) is a polymer or preferably a copolymer comprising structural units of one or more of the formulae listed below:

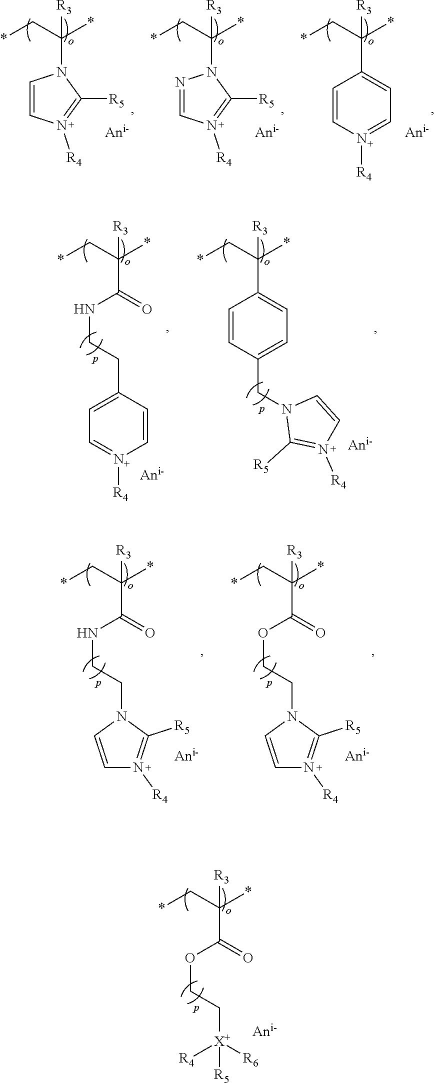

wherein
p is an integer and ranges from 1 to 100, preferably from 1 to 20 and more preferred from 1 to 6,
R₃, R₄, R₅ and R₆ are independently selected from the group of hydrogen, halogen, C₁-C₁₈ alkyl optionally substituted with one or more substituents independently selected from the group of hydroxy, carboxy, acyloxy, OR′, O₂CR′, and CO₂R′, optionally substituted aryl, optionally substituted heterocyclic rings, optionally substituted aralkyl, optionally substituted alkaryl; optionally substituted alkylthio, optionally substituted arylthiol, optionally substituted alkoxy, wherein said optional substituents are selected from the group consisting of epoxy, alkoxycarbonyl, aryloxycarbonyl, isocyanato, cyano, silyl, halo and dialkylamino, X is selected from the group of N, P, As or Sb, and
Anⁱ⁻ is an anion [Me_{q}Halᵣ]ⁱ⁻ as defined above.

In certain embodiments o ranges from 1 to 10000 and m and n range from 0 to 10000.

In certain embodiments, the polymer catalyst B) has a molar mass from 2,000 to 1,500,000 g mol⁻¹, preferably from 2,000 to 100,000 g mol⁻¹, and even more preferred from 2,000 to 50,000 g mol⁻¹. However, it is understood that other values of molar mass and polymer structures, architecture, composition, and/or combinations derived thereof are entirely possible and encompassed within the scope of the present disclosure. Molar mass is determined via size-exclusion chromatography.

Polymer B) is soluble in a broad range of solvents and solvent mixtures, preferably in polar solvents, such as, but not limited to, dimethyl sulfoxide, glycols, alcohols, and aqueous mixtures derived thereof, and in non-polar solvents, such as, but not limited to, hydrocarbon, aromatic or aliphatic solvents, and the mixtures derived thereof.

In certain embodiments, catalyst B) besides units of formula (I) further comprises segments, as represented by units of formulae (II) and/or (III) defined above, which can modify the solvophilicity (or solvophobicity, respectively) of the composition.

The molar composition ratio of units of formula (II): units of formula (I) and/or of units of formula (III): units of formula (I) are in general from 1:99 to 99:1, preferred from 90:10 to 10:90, more preferred from 80:20 to 20:80, still more preferred from 70:30 to 30:70 and most preferred from 60:40 to 40:60. These molar ratios refer to the total amount of combined units of formula (I) and (II) or of formula (I) and (III).

The molar composition ratio of units of formula (II): units of formula (III) are in general from 0:100 to 100:0, preferred from 90:10 to 10:90, more preferred from 80:20 to 20:80, still more preferred from 70:30 to 30:70 and most preferred from 60:40 to 40:60. These molar ratios refer to the total amount of combined units of formula (II) and (III).

Very preferred are catalysts B) comprising units of structural formulae (I) and (II) or structural formulae (I), (II) and (III) with the proviso, that units of formulae (II) and (III) are different from each other.

Catalysts B) may be prepared by radical polymerization of monomers of formula (Ia) and optionally of formula (IIa) and/or (IIIa)

CH₂═CR³Z (Ia),

CH₂═CR¹W (IIa),

CH₂═CR²Y (IIIa),
wherein R¹, R², R³, W, Y and Z are as defined above.

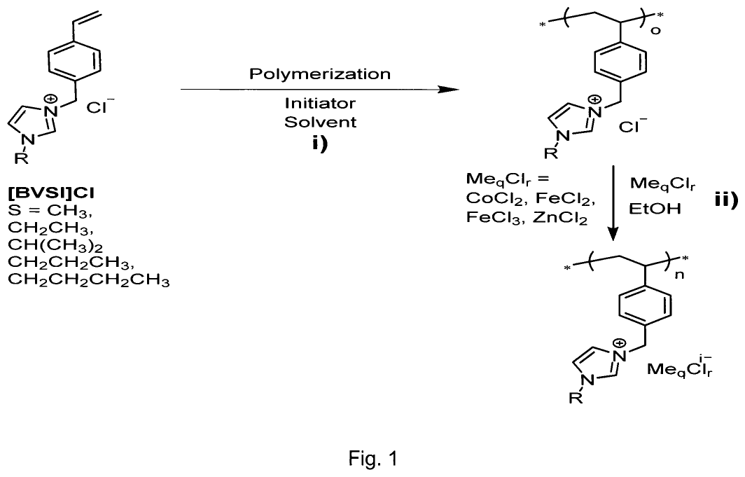

In a broad aspect, described herein is a method of making catalysts B), where the method comprises of performing polymerization reactions, for instance, but not limited to, by reversible-deactivation radical polymerization techniques of ionic monomers of formula (Ia) and optionally comonomer(s) of formula (IIa) and/or (IIIa) in suitable solvents and optionally followed by anion exchange processes with salts or ionic resins, as exemplified in FIG. 1. Other methods, combinations of methods, and/or sequences of producing catalyst derivatives are possible and entirely encompassed within the present disclosure.

Compounds suitable as comonomers of formula (IIa) and/or (IIIa) include, but are not limited to, methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates, and styrenes selected from glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethyl-acrylamide, N-tert-butylmethacrylamide, N-n-butylmethacrylamide, N-methylol-methacrylamide, N-ethylolmethacrylamide, N-tertbutylacrylamide, N-n-butyl-acrylamide, N-methylolacrylamide, N-ethylolacrylamide, vinyl benzoic acid (all isomers), diethylaminostyrene (all isomers), alpha-methylvinyl benzoic 25 acid (all isomers), diethylamine alpha-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxy-methylsilylpropyl methacrylate, diethoxymethyl-silylpropylmethacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethyl-silylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, isoprene, chloroprene, ethylene and propylene. Particularly preferred (co) monomers belong to the family of styrenics, acrylates, and methacrylates comonomers.

In the manufacture of catalyst B) a polymer or copolymer comprising structural units of formula (I) and optionally structural units of formula (II) and/or (III) may be processed by anion exchange or quaternization reactions from polymer precursors. For example, in a polymer precursor containing halogenide ions as Anⁱ⁻ these ions may become replaced by other anions Anⁱ⁻ by anion exchange to produce catalysts B) with anions [Me_{q}Halᵣ]ⁱ⁻. In common embodiments, the composition includes Lewis acidic sites as represented by ZₒM and with an estimated molar ratio of Zₒ:M from about 99:1. In certain embodiments, the estimated ratio is about 95:5, 90:10, 80:20, 70:30, 60:40, 50:50, 40:60, 30:70, and 20:80. According to the molar ratio of Zₒ:M, the resulting halometallate polymer (or polymer catalyst) will comprise a mixture of cations and one or more halometallate anions. This feature will define the properties of the polymer catalyst including Lewis acidity and catalytic activity.

In certain embodiments, the method to produce polymer catalysts B) by anion exchange comprises:
i) dissolving a halogen-containing catalyst comprising structural units of formula (I) and optionally of formula (II) and/or (III) in an aliphatic alcohol, such as ethanol, in water or in aqueous mixtures of aliphatic alcohol, preferably methanol:water compositions or ethanol:water compositions from 95:5 to 5:95,
ii) dissolving the corresponding salt for ion exchange in an aliphatic alcohol, such as ethanol, in water or in aqueous mixtures of aliphatic alcohol, preferably methanol:water compositions or ethanol:water compositions from 95:5 to 5:95,
iii) adding the salt solution of step ii) to the solution of step i) or vice versa to create a new mixture
iv) stirring and heating for a predetermined period of time, in a range of temperatures from 20° C. to 120° C. and in a range of time preferably from 1 h to 48 h,
v) precipitating the modified polymer catalyst B) by adding a suitable non-solvent, preferably, but not limited to, aliphatic hydrocarbons, ketones or ethers which are liquid at room temperature (25° C.), preferably acetone, hexane, pentane, ethyl ether, and/or mixtures thereof,
vi) filtering or decanting the mixture to separate and wash the modified polymer catalyst B) with suitable solvents, and optionally
vii) drying and pulverizing the modified polymer catalyst B).

In in improved process variant, the anion exchange is further completed by fusing the modified catalyst B) in a range of temperatures from 80° C. to 180° C.

In preferred embodiments, catalyst B) is made by anion exchange between Cl-type polymer catalysts B) and ZnCl₂ in a liquid medium. The resulting polymer catalysts B) contain [Zn_{q}Clᵣ]ⁱ⁻ anions and have stimuli-responsive behavior, preferably but not limited to temperature, in alcohols or glycols and in alcohol and glycol solutions, including aqueous solutions derived thereof. In one aspect, this disclosure provides stimuli-responsive solutions of these polymer catalysts B) containing [Zn_{q}Clᵣ]ⁱ⁻ anions in glycols or alcohols, assisted by the application of heating and/or ultrasound to the polymer solution. The solutions of catalysts B) containing [Zn_{q}Clᵣ]ⁱ⁻ anions have reversible spontaneous thermo-responsive behavior known as Upper Critical Solution Temperature (UCST) and/or Lower Critical Solution Temperature (LCST); thus, forming heterogeneous dispersions of particles at a given temperature, which can be homogenized in solutions at temperatures higher than the UCST or at temperatures lower than the LCST of the polymer system, respectively.

Catalyst B) contains Lewis acidic sites useful for (trans)esterification/(trans)amidation or depolymerization reactions. The number of catalytic sites can be customized to modify the properties and catalytic performance of the polymer catalysts B). The composition includes Lewis acidic sites at an estimated Zₒ:M molar ratio of up to about 99:1. In certain embodiments, the estimated Zₒ:M ratio is about 95:5, 90:10, 80:20, 70:30, 60:40, 50:50, 40:60, 30:70, and 20:80. In common embodiments, polymer catalyst B) has a sufficient Zₒ:M molar ratio to increase the thermal stability of the polymer catalyst B) from about 200° C. to about 400° C., particularly 250° C. to about 350° C.; thus, the polymer catalyst B) is suitable for catalytic reactions performed in a broad range of temperature.

Catalysts B) may further comprise segments of formula (II) and/or (III) that adjust the solvophilicity or solvophobicity of the copolymer. The structure and content of formula (II) or formula (III) segments of the copolymer catalyst B) is used to customize the physicochemical properties, the catalytic performance, and the recovery capacity of the polymer catalysts B) produced. Molar ratios of units of formula (I) and units of formula (II) and/or (III) are given above. Thus, catalyst B) may be further modified in a plurality of ways encompassed within the present disclosure.

Another aspect described herein is a stimuli-responsive polymer solution comprising soluble catalyst B) derivatives and alcohols such as glycols, and aqueous mixtures derived thereof, where mixtures of catalyst B) in the corresponding solvents are in a range from 0.1 to 50 wt. % of polymer concentration, more preferably from 1.0 to 20 wt. %, and are soluble or dispersible in all proportions. In certain embodiments, the dispersion of catalyst B) in alcohols and aqueous mixtures derived thereof is favored by applying heating and/or ultrasonics for a period of preferably from about 0.01 h to about 5 h, more preferably from about 0.25 h to 2 h.

In preferred embodiments, derivatives of catalyst B) are used as thermo-responsive polymer catalysts as they favor the spontaneous unmixed state at room temperature in glycol solutions but become soluble at elevated temperatures (i.e., above the cloud point (T_{CP}) of the solution). In common embodiments, mixtures of catalyst B) having [Zn_{q}Clᵣ]-anions in glycols or glycerol have a reversible and spontaneous thermo-responsive UCST behavior. These mixtures include solvents such as, but not limited to, 1,2-ethanediol (ethylene glycol, EG); 1,3-propanediol (trimethylene glycol); 1,4-butanediol (tetramethylene glycol); 1.5-pentanediol (pentylene glycol or pentamethylene glycol); and propane-1,2,3-triol (glycerol). Below the T_{CP}, the mixtures of catalyst B) having [Zn_{q}Clᵣ]-anions in glycols or glycerol form two-phase systems consisting of aggregated polymer chains dispersed in a continuous medium of the corresponding solvent. The UCST behavior and size of the formed polymer aggregates or particles may be varied and fine-tuned by means of, for instance, copolymer composition and architecture of catalyst B) concentration and temperature of the solution. Furthermore, derivatives of catalyst B) having [Zn_{q}Clᵣ]-anions show thermo-responsive behavior in glycol or glycerol solutions that may contain fractions of H₂O in a glycol/glycerol:H₂O range from about 99:1 to about 10:90, preferably from about 99:1 to about 90:10.

The average size of the formed catalyst B) particles in glycol/glycerol solutions can be, for instance, up to 10,000 nm. In common embodiments, the size ranges from 10 to 1000 nm. The size of the particles can be controlled by varying the ZnCl₂ ratio during the synthesis of catalyst B), solvents and mixtures derived thereof, catalyst B) concentration, and external stimuli, where temperature is preferred. In the temperature range of applications of catalyst B) having [Zn_{q}Clᵣ]-anions, their unique thermo-responsive properties in alcohol solutions promote the diffusion of polymer catalyst chains and anions through the reagents of (trans)esterification reactions (e.g., polyesters to be depolymerized). For instance, the temperature of the depolymerization reaction of polyesters is chosen at a temperature above the UCST of catalyst B) having [Zn_{q}Clᵣ]-anions in etylene glycol (EG) solution. By dissolving the polymer catalyst in EG at suitable temperatures, their ionic species (i.e., Lewis acidic sites) promote the catalytic reaction by means of glycolysis at one or more of these catalytic sites along the ester groups of the polymer chains of polyesters. The catalysts B) having [Zn_{q}Clᵣ]-anions are particularly useful for the depolymerization of polyesters (e.g., but not limited to, polyethylene terephthalate (PET)) into oligomers and monomers. Furthermore, the thermo-responsive characteristics of the polymer catalysts disclosed herein are beneficial for the depolymerization of polyesters and selectivity for monomers since the solubilized polymer chains in a homogeneous medium promote a high diffusion of the catalytic sites at the conditions of the (trans)esterification or depolymerization reactions. Notably, further embodiments show that the catalysts B) having [Zn_{q}Clᵣ]-anions and having solvophilic and/or solvophobic segments of formulae (II) and/or (III) promote the depolymerization of polyesters and selectivity for monomers since the solvophilic and/or solvophobic fractions promotes effective interactions between the ester groups of polyesters and the corresponding catalytic sites of the polymer catalyst B).

In preferred embodiments, the content of solvophilic: solvophobic comonomer composition ratio of the polymer catalysts B) that favored their catalytic performance in (trans)esterification/(trans)amidation reactions or depolymerization of polyesters or polyamides is in the range from about 99:1 to 1:99, preferably from about 80:20 to 20:80, even more preferably from about 60:40 to about 40:60.

In certain embodiments, the polymer catalysts B) comprising solvophilic and/or solvophobic segments of formula (II) and/or (III) facilitate the separation of impurities from the products of (trans)esterification/(trans)amidation reactions or depolymerization reactions. In particular embodiments, the catalysts B) disclosed herein formed well-defined particles with homogeneous populations and an average particle size of approximately 10 nm to about 1000 nm in EG solutions at temperatures below the UCST of the respective system. The size of particles may be modified by varying the physicochemical properties of the polymer catalysts B) and/or corresponding catalytic reaction systems. The access to moieties of catalysts B) of nanometric sizes facilitates the catalytic performance of polymer catalysts B) during (trans)esterification/(trans)amidatino reactions or depolymerization of polyesters/polyamides, and the subsequent separation of solvophobic and/or solvophilic impurities (e.g., but not limited to additives and colorants) from the products derived from such catalytic reactions.

In another aspect, this disclosure provides a method for transesterification or transamidation reactions and preferred for the depolymerization of polyesters or polyamides and the purification of the products derived thereof.

The invention therefor also relates to a method of degrading a polymer material A) chosen from the group of polyesters and/or polyamides in a degradation reaction catalysed by a catalyst B) in a carrier liquid C), which method comprises the steps of:
i) providing the polymer A) to be degraded, the catalyst complex B) and the carrier liquid C), as hereinto before defined,
ii) mixing catalyst B), polymer A) to be degraded, and carrier liquid C);
iii) carrying out the degradation reaction to obtain a mixture comprising monomers, oligomers, carrier liquid C) and catalyst B),
iv) adding a polar medium, particularly water or an aqueous solution of aliphatic alcohol, to the mixture from step iii), to obtain a first hydrophilic phase comprising monomers and catalyst B) and a second hydrohobic phase comprising oligomers; and
v) separating the first hydrophilic phase from the second hydrophobic phase.

In one preferred embodiment, the invention relates to a method for the depolymerization of polyesters or polyamides comprising the steps of:
i) providing the polyester and/or polyamide A) to be depolymerized and the catalyst B),
ii) mixing polyester and/or polyamide A) to be depolymerized, catalyst B) and a suitable solvent or mixture of solvents C),
iii) performing the depolymerization reaction by heating the mixture obtained in step ii) to obtain a homogeneous mixture of monomers, oligomers, impurities, catalyst and solvent,
iv) optionally cooling the mixture obtained in step iii),
v) adding a polar medium, particularly water or an aqueous alcoholic solution, to the mixture, to obtain a two-phase dispersion with a first solvophilic phase comprising depolymerization products and catalyst B) and with a second solovophobic phase comprising oligomers and impurities,
vi) separating the first phase from the second phase, preferably by filtration, decantation, or the like techniques,
vii) separating the main depolymerization product from the first solvophilic phase by crystallization followed by separation of the crystalline phase, preferably by filtration, decantation, or the like techniques,
viii) separating the catalyst B) from the first solvophilic phase by applying an external stimulus, particularly temperature, followed by removal of catalyst B), preferably by filtration, decantation, centrifugation, or the like techniques to recover catalyst B) from the solution, or, alternatively, re-using the first solvophilic phase containing catalyst B) or re-using the first solovophilic phase to which an additional amount of catalyst B) has been added to perform additional depolymerization reactions.

In another preferred embodiment, the invention relates to a method for transesterification or transamidation of (poly)esters or (poly)amides comprising the steps of:
i) providing the (poly)ester and/or (poly)amide A) to be transesterified or transamidated, the catalyst B), an alcohol and/or an amine D),
ii) mixing polyester and/or polyamide A) to be transesterified or transamidated, catalyst B), alcohol and/or amine D) and optionally a suitable solvent or mixture of solvents C),
iii) performing the transesterification or transamidation reaction by heating the mixture obtained in step ii) to obtain a homogeneous mixture of monomers, oligomers, impurities, catalyst and solvent,
iv) optionally cooling the mixture obtained in step iii),
v) adding a polar medium, particularly water or an aqueous alcoholic solution, to the mixture, to obtain a two-phase dispersion with a first solvophilic phase comprising transesterification or transamidation products and catalyst B) and with a second solovophobic phase comprising oligomers and impurities,
vi) separating the first phase from the second phase, preferably by filtration, decantation, or the like techniques,
vii) separating the main transesterification or transamidation product from the first solvophilic phase by crystallization followed by separation of the crystalline phase, preferably by filtration, decantation, or the like techniques,
viii) separating the catalyst B) from the first solvophilic phase by applying an external stimulus, particularly temperature, followed by removal of catalyst B), preferably by filtration, decantation, centrifugation, or the like techniques to recover catalyst B) from the solution, or, alternatively, re-using the first solvophilic phase containing catalyst B) or re-using the first solovophilic phase to which an additional amount of catalyst B) has been added to perform additional transesterification or transamidation reactions.

The polymer catalyst is particularly useful for the depolymerization of polyesters into oligomers and monomers or for transesterification of (poly)esters, such as triglycerides, into transesterified (poly)esters. The stimuli-responsive polymer catalysts B) are beneficial for the efficient (trans)esterification and depolymerization of polyesters because they combine the high surface area of soluble polymer chains, promoting a high diffusion of their catalytic sites in homogeneous catalytic reaction systems.

In another aspect, this disclosure provides a method of catalyst separation using the stimuli-responsive features of the functional polymer catalyst B) and applying external stimuli after the isolation of (trans)esterification/(trans)amidation or depolymerization products and by-products.

In certain embodiments, the present invention also provides a method comprising the separation of stimuli-responsive polymer catalyst B) and impurities from the products of (trans)esterification/(trans)amidation or depolymerization involving preferably the thermo-responsive features of these multifunctional catalysts B) in alcohols or glycols and aqueous mixtures derived thereof. In an example of the present invention, after separating depolymerization products and impurities, the catalyst complex might be precipitated to form particle aggregates below its UCST to yield heterogeneous dispersions. Moreover, it is demonstrated that the use of complex polymer catalysts B) with tailored solvophilic and/or solvophobic functionalities and structures is effective for the depolymerization of post-consumer polyesters/polyamides and the subsequent separation of colorants, such as pigments or dyes, from the depolymerization products. It is described herein that a variety of colorants can be removed by taking advantage of the functionalities of the functional polymer catalyst B) and methods disclosed herein. Therefore, monomeric substances of a high purity are obtained, which can be readily used for the subsequent preparation of new or recycled polyester or polyamide materials.

The (trans)esterification/(trans)amidation or polyester/polyamide depolymerization reactions of the present invention are carried out, but not limited to, at ambient atmosphere, with temperatures in the range from about 150° C. to about 250° C., and pressure ranging from 0 to about 50 atm.

In common embodiments, the reaction is conducted under ambient pressure and temperatures in the range from about 160° C. to about 220° C., and preferably from 170 to 200° C.

The depolymerization reactions require no additional solvent or reactants because alcohols or aqueous solutions derived thereof function as both solvents and reactants. The reaction mixture is typically and constantly, although not necessarily, mixed by different means known in the art (e.g. stirred mechanically or magnetically, for instance, in batch or continuous stirred tank reactors (CSTR) or static mixing in plug flow reactors (PFR)). Mechanical stirring can be provided to the (trans)esterification/(trans)amidation or depolymerization reaction systems by suitable impellers known in the art, at stirring speeds in the range from 50 to 1200 rpm, more preferably in the range from 200 to 800 rpm.

Standard analytical techniques known in the art (e.g., NMR, GPC, HPLC, GC, and IR or UV spectroscopy) can generally monitor the progress of (trans)esterification/(trans)amidation reactions or depolymerizations of polyesters/polyamides by estimating the concentration of yielded products (e.g. monomers and/or oligomers).

The purity of the products yielded from said reactions can be determined using standard analytic techniques known in the art (e.g. NMR, GPC, HPLC, GC, and IR or UV spectroscopy).

In some embodiments the polymer catalyst B) disclosed herein can be present in (trans)esterification/(trans)amidation reactions or depolymerization reactions from 0.1 wt. % to 20 wt. %, preferably from 1 wt. % to 10 wt. %, relative to the total amount of feedstock or polyester/polyamide to be depolymerized.

In such embodiments, alcohols and aqueous mixtures derived thereof used as both solvents and reactants can be in the concentration range from about 0.1 wt. % to about 99.5 wt. %, more preferably, from about 50 wt. % to about 97.5 wt. %, even more preferably from about 75 wt. % to about 95 wt. %, relative to the total amount of feedstock or polyester/polyamide to be depolymerized or reacted in the (trans)esterification/(trans)amidation reaction.

The diester monomer yielded as the main product from the catalytic depolymerizations of polyesters disclosed herein has the general formula

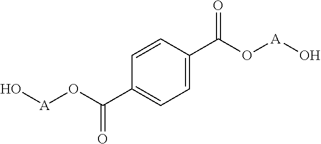

Therein A is a divalent group comprising 2 to 5 carbons. Exemplary divalent groups for the A moieties include, but are not limited to, ethyl, n-propyl. 2-propyl, n-butyl, iso-butyl, n-pentyl nd/or iso-pentyl. In preferred embodiments, the polyester is poly(ethylene terephthalate) (PET), the glycol is ethylene glycol (EG), and the monomer ester is bis(2-hydroxyethyl) terephthalate (BHET).

In common embodiments, the glycolytic depolymerization of PET to produce BHET, using catalyst B), is depicted as follows: (i) forming a reaction mixture comprising: PET, EG and catalyst B); (ii) heating up the reaction mixture to a temperature from 150° C. to 250° C. to produce an homogeneous mixture after depolymerizing the PET and forming a soluble product comprising mainly of BHET; (iii) cooling down the reaction mixture to a temperature in the range from 0° C. to 100° C. and adding water to produce an aqueous solution; (iv) separating the non-soluble impurities from the products by means of decantation, filtration or centrifugation; (v) cooling down the aqueous solution to a temperature in the range from −5° C. to 10° C. to crystallize the monomer product (BHET); (vi) isolating and drying the crystallized monomer product (BHET), from the aqueous solution by decantation, filtration or centrifugation; (vii) removing water from the remaining aqueous solution by vacuum distillation; (viii) according to the feedstock, washing the remaining organic solution containing EG and the polymer catalyst B) (with organic solvents and/or activated coal or ionic resins) to remove by absorption and/or adsorption any remaining impurities (e.g., additives and/or colorants); (ix) reusing the remaining EG solution containing the polymer catalyst B) to perform further transesterification or depolymerization reactions and/or isolating the polymer catalyst B) by cooling down the remaining EG solution to allow the precipitation of the thermo-responsive polymer catalyst followed by a separation via decantation, filtration, centrifugation, or the like techniques.

Furthermore, as described above, the isolated solid polymer catalyst B) or the polymer catalyst B) in EG solution may be reused in subsequent catalytic (trans)esterification/(trans)amidation or depolymerization reactions.

The present invention also provides a method comprising the separation of a stimuli-responsive polymer catalyst B) and impurities from depolymerization products, which preferably involves the thermo-responsive behavior of the polymer catalysts B) in alcohols or aqueous mixtures derived thereof. In an example of the present invention, after separating (trans)esterification/(trans)amidation or depolymerization products and impurities, the polymer catalyst B) can be precipitated to form aggregated particles well below its UCST to form two-phase dispersions with a continuous phase corresponding to reaction solvent (e.g. alcohols or aqueous mixtures derived thereof) and a second phase containing dispersed polymer aggregates. The UCST behavior of the solution containing the polymer catalysts B) will be governed by the composition and concentration of polymer as well as the content of water or other cosolvents. Moreover, the polymer catalysts B) disclosed herein, comprising tailored solvophilic and/or solvophobic functionalities and architectures, are effective for (trans)esterification/(trans)amidation reactions or for the depolymerization of polyesters/polyamides including the isolation of impurities or colorants such as, but not limited to, pigments and dyes.

Thus, a variety of impurities and colorants can be removed with the method disclosed herein. Therefore, highly pure products or monomers can be obtained, which can be readily reused, for instance, but not limited to, the preparation of recycled polyesters/polyamides.

In common embodiments, after adding water or a suitable solvent to the solution obtained from (trans)esterification/(trans)amidation reactions or depolymerization reactions, solvophobic additives and/or colorants can be removed by methods known in the art such as, but not limited to decantation, filtration, or ultracentrifugation. Whereas some more solvophilic colorants can remain in the solution containing the depolymerization products, the polymer catalysts B) and solvent. Notably, further embodiments of the polymer catalysts B) containing solvophilic and/or solvophobic segments can be utilized for further removing solvophilic pigments and dyes from the products of the reactions or from the monomers derived from the depolymerization. Suitably, the dyes and pigments may have affinity for the particles of the polymer catalyst B) further improving the purity of the products or monomers obtained from the catalytic (trans)esterification/(trans)-amidation reactions or depolymerizations disclosed herein. Therefore, monomers or product of high purity can be isolated by separation methods known in the art such as, but not limited to, crystallization.

Impurities, dyes and/or pigments in the remaining solution can thereafter be removed from the polymer catalyst B) solution by separation methods known in the art such as, but not limited to, absorption with suitable solvents or adsorption with materials of large surface area known in the art such as, but not limited to, active charcoal, ionic resins, silica particles, zeolites or metal organic frameworks.

In accordance with common embodiments of the disclosure, the remaining solution containing the polymer catalyst B) can be either reused for additional (trans)-esterification/(transamidation or depolymerization reactions or subjected to temperatures below their respective UCST to aggregate the polymer catalyst B) for quantitative recovery followed by washing and drying procedures. Thus, the recovered polymer catalyst B) can be reused as it is or in combination with additional pristine polymer catalyst B) to perform new catalytic reactions. This is advantageous for customizing processes at industrial scales because the final products of depolymerization or (trans)esterification/(trans)amidation reactions are purified in a single procedure.

In common embodiments, the polymer catalyst B) disclosed herein is reused in further depolymerization cycles by using the remaining solution of polymer catalyst B)/EG. The solution of polymer catalyst B)/EG can be stored for an indefinite period of time without loss of catalytic activity. In a representative embodiment, the polymer catalyst B) is recycled several times by adding additional solvent (EG) and post-consumer PET feedstock into the remaining polymer catalyst/EG solution. Thereafter, the new depolymerization cycle is performed as described before. Interestingly, it is demonstrated in the examples below that the catalytic activity of the polymer catalyst B) is enhanced in subsequent depolymerization reaction cycles. Thus, the polymer catalysts B) described herein keep their catalytic activity and can be used in adaptable closed-loop chemical recycling processes with a minimal waste.

The methods described herein allow for the recovery of a monomer diester or of monomer diamide from a crude depolymerization reaction product. Where the polyester is a terephthalate, the amount of monomer diester BHET in a crude reaction product may range from about 80 wt. % to 100 wt. %, particularly 90 wt. % to 99.9 wt. %, or more particularly 94 wt. % to 99 wt. % of selectivity, based on the weight of the crude polyester reaction product (containing monomer and oligomers). The amount of oligomers (e.g., dimers and trimers) can be somewhat controlled by the concentration of the reactant polyester in the alcohol or glycol reactant/solvent or mixtures derived thereof. The depolymerization of the reactant polyester into diester monomer and oligomer products is typically quantitative and can be monitored by common analytical techniques known in the art. In the PET to monomer diester depolymerization reaction described herein, the amount of terephthalate oligomers present in the crude product can range from 0.1 wt. % to less than 10 wt. %, particularly 0.1 wt. % to 1 wt. %, based on the weight of the reaction product (i.e., containing monomer and oligomers).

Upon completion of the depolymerization procedure, the described embodiments demonstrate that the monomer diester or diamide reaction products do not require further purification steps because they contain low to null amounts of oligomers, colorants, solvents, and/or residual polymer catalyst B) fractions. Notably, the obtained monomer reaction products show low to null coloration, as determined by standard analytical techniques known in the art. Furthermore, the use of specific post-consumer polyesters/polyamides or mixtures derived thereof has no significant effect on the overall conversion and selectivity of the catalytic systems disclosed herein. Thus, additional steps to further purify the product are unnecessary, and the monomer diester/diamide reaction product may be directly re-polymerized or copolymerized to produce upcycled polyester/polyamide materials. Hence, the polymer catalysts B) and methods described herein can facilitate the efficient recycling of post-consumer products. In particular, the chemical recycling of polyester products, via alcoholysis or glycolysis catalyzed by the polymer catalysts B) disclosed herein, provides useful capabilities to improve the catalytic activity and the removal of catalysts and/or impurities by implementing functional stimuli-responsive features into polymer catalysts B) to conveniently switch from efficient homogeneous catalytic reaction systems to efficient heterogeneous separation methods in the same catalytic reaction process.

The invention also relates to the use of compounds B) as catalysts in the depolymeriziation of polyesters or polyamides and in (trans)esterification reactions or in (trans)amidation reactions.

### EXAMPLES

The following examples are provided to illustrate the synthesis and characterization of polymer catalysts and their use in depolymerization of polyester methodologies described in the invention disclosed herein. They are intended solely as possible methods described by way of examples without limiting the invention to their contents or specific application. While efforts have been made to ensure accuracy with respect to variables such as amounts, temperature, among others, experimental error, and deviations should be considered.

In these examples structural units of formula (I) having anions Anⁱ⁻ are characterized as ZₒM, structural units of formula (II) are characterized as Wₘ, and structural units of formula (III) are characterized as Yₙ. Polymers comprising structural units of formulae (I), (II) and (II) and having anions Anⁱ⁻ are characterized as P[WₘYₙZₒM].

Materials purchased or prepared in the following examples are described as follows:

P[WₘYₙZₒM] Synthesis

1-Methyl imidazole (99%), 1-butyl imidazole (98%), and the monomers 2-(dimethylamino)ethyl methacrylate (DMAEMA, 98.5%), methyl methacrylate (MMA, 99%) and 4-vinylbenzyl chloride (90%) were acquired from TCI Chemicals.

Ionic monomer precursors (1-alkyl-3-(4′-vinylbenzyl)-1H-imidazol-3-ium chloride, [BVSI]Cl) were prepared according to the procedure of Bara et al., Ind. Eng. Chem. Res. 46 (2007) 5397-5404. https://doi.org/10.1021/ie0704492. 4,4′-Azobis(4-cyanovaleric acid) (ACVA, 75%) and 1,3,5-trioxane (>99%) were acquired from Sigma-Aldrich and used without further purification.

Monomers were treated with inhibitor removers prior to use.

The CTA agent 4-Cyano-4-[(dodecylsulfanyl-thiocarbonyl) sulfanyl] pentanoic acid (CDTPA, 97%) was obtained from STREM Chemicals.

The salts used for examples of anion exchange reactions (ZnCl₂ (98%), FeCl₃ (99%), and CoCl₂ (98%) were acquired from Sigma Aldrich and used as received.

### Polyethylene Terephthalate (PET) Depolymerization

PET flakes (A˜2 mm²) were obtained from post-consumer PET beverage bottles and food containers. Different colorations of waste materials were used including transparent, green, gray, brow, pink, and blue beverage bottles and black, golden, yellow, and gray food containers. Before the depolymerization procedure, the PET flakes were washed with H₂O and methanol (three times each). The final flakes were filtrated and dried in a vacuum oven at 90° C. for 12 h.

Solvents: ethylene glycol (EG, 99%), glycerol (99%), and 1,3-propanediol (98%) were acquired from Aldrich and used as received.

### Example 1—Preparation of Homopolymers (P[WₘYₙZₒCl])

Polymerizations were performed in a commercially available automated parallel synthesizer (ASW2000) from Chemspeed Technologies AG (Switzerland). According to the procedure of Guerrero-Sanchez et al., (https://doi.org/10.1021/co300044w) Reversible Addition-Fragmentation Chain Transfer (RAFT) polymerization experiments were performed as described in the following examples.

Examples of production of P[WₘYₙZₒM] through polymerization of an ionic monomer [BVSRI]Cl and anion exchange with metallic salts (Me_{q}Clᵣ) are shown in FIG. 1.

The series of P[WₘYₙZₒCl] homopolymers of variable degree of polymerization was obtained by RAFT polymerization of imidazole monomer derivatives [BVSI]Cl with variable alkyl substituents (FIG. 1). A representative synthesis procedure is as follows:

A septum sealed flask was charged with the stated quantities of the corresponding [BVSI]Cl monomer, solvophilic monomer, solvophobic monomer, ACVA, CDTPA and 1,3,5-trioxane. Details of synthesis und characterization of the polymers are given in Tables 1 to 7.

TABLE 1
Experimental details for the synthesis of homopolymers P[WₘYₙZₒCl].^{a)}

| | | | Solvent | Monomer | CPDAB | ACVA | Trioxane |
|---|---|---|---|---|---|---|---|
| Entry | P[WₘYₙZₒCl] | [M/CTA] | [mL] | [mmol] | [mmol] | [mmol] | [mmol] |
| A1 | P([BVMI]Cl) | 23.02 | 8.0 | 5.0 | 0.217 | 0.043 | 0.710 |
| A2 | P([BVMI]Cl) | 44.32 | 8.0 | 5.0 | 0.056 | 0.011 | 0.710 |
| A3 | P([BVMI]Cl) | 123.3 | 25.6 | 16.5 | 0.134 | 0.020 | 2.27 |
| A4 | P([BVMI]Cl) | 214.7 | 25.6 | 16.5 | 0.077 | 0.012 | 2.27 |
| B1 | P([BVBI]Cl) | 18.0 | 5.4 | 7.2 | 0.40 | 0.080 | 0.60 |
| B2 | P([BVBI]Cl) | 36.1 | 5.4 | 7.2 | 0.20 | 0.040 | 0.60 |
| B3 | P([BVBI]Cl) | 72.3 | 5.4 | 7.2 | 0.10 | 0.020 | 0.60 |

^{a)}P([BVMI]Cl) = Poly(1-methyl-3-(4′-vinylbenzyl)-1H-imidazol-3-ium chloride); P([BVBI]Cl) = Poly(1-butyl-3-(4′-vinylbenzyl)-1H-imidazol-3-ium chloride).

The mixture was dispersed in dimethyl sulfoxide (DMSO) and stirred until dissolution. Then, the reaction mixture was charged into the automated parallel synthesizer reactors and degassed by sparging N₂ for 20 minutes. Subsequently, the reactor block was sealed under a nitrogen atmosphere and heated for 16 to 24 h. The onset of the polymerization was considered once the reaction temperature was reached. The monomer conversion was followed by 1H NMR by withdrawing samples from the reactors at various times. After the reaction time had elapsed, the polymer solution was concentrated by vacuum evaporation, redissolved in water, and purified by dialysis (48 h, r.t., 1 kDa MWCO). The final product was freeze-dried for 48 to 72 h to obtain a yellowish solid. The resulting P[WₘYₙZₒCl] showed controlled values of Mₙ and dispersity (D) as estimated by SEC (determined in aqueous solutions of trifluoroacetic acid (TFA, 0.3%) and NaCl 0.1 M [pH<2] as eluent at a flow rate of 1 mL min⁻¹ (RI detection, 2-polyvinyl pyridine (P2VP) standards (Mₚ=1,300 to 81,000 g mol⁻¹)) and ¹H NMR (Table 2).

TABLE 2
Characterization of homopolymers P[WₘYₙZₒCl]

| | | Time | Conv. | M_{n, theo} ^{b)} | M_{n, NMR} ^{c)} | M_{n, SEC} ^{d)} | |
|---|---|---|---|---|---|---|---|
| Entry | P[WₘYₙZₒCl] | [h] | [%] ^{a)} | [kg mol⁻¹] | [kg mol⁻¹] | [kg mol⁻¹] | Ð ^{d)} |
| A1 | P([BVMI]Cl) | 16 | 69.9 | 7.55 | 7.82 | 3.79 | 1.07 |
| A2 | P([BVMI]Cl) | 16 | 63.0 | 13.11 | 12.14 | 5.13 | 1.08 |
| A3 | P([BVMI]Cl) | 24 | 60.0 | 17.61 | 15.78 | 5.34 | 1.32 |
| A4 | P([BVMI]Cl) | 24 | 58.9 | 29.47 | 24.07 | 10.97 | 1.39 |
| B1 | P([BVBI]Cl) | 24 | 94.5 | 4.73 | 5.55 | 2.31 | 1.17 |
| B2 | P([BVBI]Cl) | 24 | 89.9 | 8.99 | 8.48 | 3.52 | 1.20 |
| B3 | P([BVBI]Cl) | 24 | 91.4 | 18.28 | n.d. ^{e)} | 5.49 | 1.20 |

^{a)} Estimated by ¹H NMR, T = 80° C.;
^{b)} determined by the formula M_{n, theo} = [([M_{[BVSI]Cl}]₀/[CPDAB]ₒ × Conv. × M_{[BVSI]Cl}] + M_{CPDAB}};
^{c)} estimated by ¹H NMR using as a reference the signals of CPDAB (δ = 0.5 to 0.8 ppm) and P([BVMI]Cl) (δ = 10.1 ppm);
^{d)} determined by SEC in an aqueous solution containing TFA and NaCl (RI detection, P2VP calibration);
^{e)} not determined due to insufficient intensity of the reference signal.

### Example 2—Preparation of Statistical Copolymers P[WₘYₙZ_{q}Cl]

A series of copolymers with variable monomer composition was obtained using the automated synthesizer and polymerization method described in Example 1. Table 3 summarizes the experimental details for the synthesis of statistical hydrophilic copolymers.

TABLE 3
Experimental details for the synthesis of statistical copolymers P[WₘYₙZₒCl]

| | | | Solvent | [BVBI]Cl | DMAEMA | CPDAB | ACVA | Trioxane |
|---|---|---|---|---|---|---|---|---|
| Entry | P[WₘYₙZₒCl] | [M/CTA] | [mL] | [mmol] | [mmol] | [mmol] | [mmol] | [mmol] |
| C1 | P([BVBI]Cl-co-DMAEMA | 43.3 | 7.5 | 3.0 | 0.75 | 0.051 | 0.008 | 0.667 |
| C2 | P([BVBI]Cl-co-DMAEMA | 49.0 | 7.5 | 2.3 | 1.5 | 0.052 | 0.008 | 0.667 |
| C3 | P([BVBI]Cl-co-DMAEMA | 54.7 | 7.5 | 1.5 | 2.3 | 0.054 | 0.008 | 0.667 |
| C4 | P([BVBI]Cl-co-DMAEMA | 51.9 | 7.5 | 1.9 | 1.9 | 0.054 | 0.008 | 0.667 |
| C5 | P([BVBI]Cl-co-DMAEMA | 60.5 | 7.5 | 0.75 | 3.0 | 0.055 | 0.008 | 0.667 |

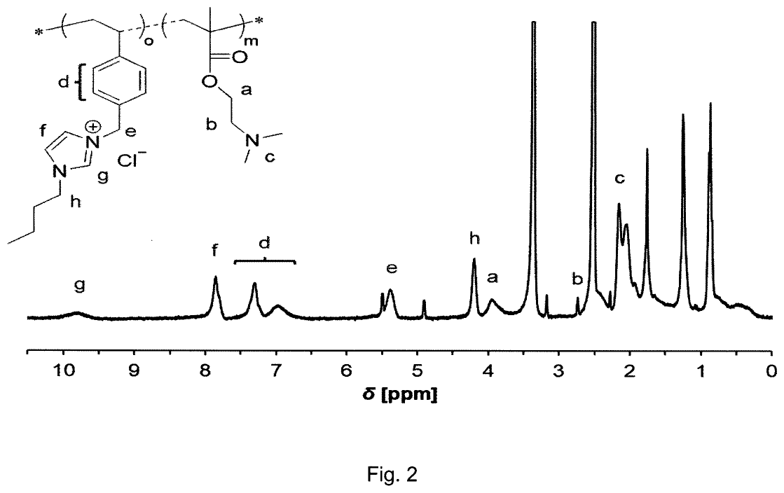

The composition of the final copolymers was calculated by comparing the integration resonance of PDMAEMA (2H, δ=3.9 ppm) and P [BVBI]Cl δ=4.3) in DMSO-d₆. FIG. 2 shows an example of a purified polymer, with the assigned ¹H NMR signals corresponding to both fragments of (co) polymers.

TABLE 4
Characterization of statistical copolymers P[WₘYₙZₒCl].

| | M_{n, theo} | Conversion [%] ^{b)} | | Feed ratio | Final Composition | Mn | |
|---|---|---|---|---|---|---|---|
| Entry | [kg mol⁻¹] ^{a)} | [BVBI]Cl | DMAEMA | [BVBI]Cl:DMAEMA | [BVBI]Cl:DMAEMA ^{c)} | [kg mol⁻¹] ^{d)} | Ð ^{d)} |
| C1 | 10.54 | 0.60 | 0.40 | 0.8:0.2 | 0.72:0.28 | 2.09 | 1.8 |
| C2 | 9.48 | 0.65 | 0.50 | 0.6:0.4 | 0.5:0.5 | 2.92 | 1.68 |
| C3 | 9.31 | 0.65 | 0.60 | 0.4:0.6 | 0.42:0.58 | 3.50 | 1.71 |
| C4 | 13.4 | 0.9 | 0.72 | 0.5:0.5 | 0.65:0.35 | 4.22 | 1.6 |
| C5 | 8.56 | 0.66 | 0.55 | 0.2:0.8 | 0.26:0.74 | 4.08 | 1.84 |

^{a)} Determined by the formula M_{n, theo} = {[([M_{[BVBI]Cl}]ₒ/[CTA]ₒ × Conv. × M_{[BVBI]Cl}] + [([M_{DMAEMA}]ₒ/[CTA]ₒ × Conv. × M_{DMAEMA}] + M_{n, CTA}};
^{b)} determined by ¹H NMR in DMSO-d₆, T = 85° C.;
^{c)} determined after purification by ¹H NMR in DMSO-d₆.
^{d)} determined by SEC in an aqueous solution containing TFA and NaCl (RI detection, P2VP calibration).

FIG. 2 shows the ¹H NMR spectrum of a sample of P[WₘYₙZₒCl] copolymers (Sample C4).

### Example 3—Preparation of Quasi-Block and Block Copolymers P[WₘYₙZₒCl]

Synthesis of PDMAEMA and PMMA macroCTA agents. Different macro chain transfer agents (macroCTA) were prepared according to the following method: Pre-determined quantities of CPADB, ACVA initiator, and 1,3,5-trioxane were dissolved in the corresponding solvent (Table 5). The mixture was then transferred to the automated parallel synthesizer reactors. Thereafter, a pre-determined amount of solvophilic or solvophobic monomer was added into the reactors to yield a total reaction volume of 20 mL with an initial monomer concentration of 1 to 4 M. By varying CPADB concentration, different degrees of polymerization (DP) were targeted (assuming 100% monomer conversion). These reaction mixtures were degassed by sparging N₂ for 20 minutes. Subsequently, the reactor block was sealed under a nitrogen atmosphere and heated for 5 to 15 h; the reflux condenser temperature was set at 5° C. The onset of the polymerizations was considered once the reaction temperature was reached. The monomer conversion was followed by 1H NMR by withdrawing samples from the reactors at various times. After the pre-desired conversion of monomer was reached, the polymer solution was concentrated by vacuum evaporation. Finally, MacroCTA I to III were purified by three dissolution (in THF)/precipitation (cold hexane) cycles. The final product was dried in a vacuum oven at 40° C. to obtain a yellowish-brittle solid. MacroCTA IV was purified by three dissolution (in acetone)/precipitation (methanol) cycles; the final product was dried in a vacuum oven as previously described. Experimental details of the synthesis are found in Table 5.

TABLE 5
Experimental details for the synthesis of MacroCTA agents I-IV.

| | | Time | Conv. | | Solvent | Monomer | RAFT | ACVA | Trioxane |
|---|---|---|---|---|---|---|---|---|---|
| MacroCTA | Polymer | [h] | [%] ^{c)} | [M/CTA] | [mL] | [mmol] | [mmol] | [mmol] | [mmol] |
| I ^{a)} | PDMAEMA | 6 | 68 | 66 | 60 | 60 | 0.91 | 0.01 | 5.33 |
| II ^{a)} | PDMAEMA | 6 | 58 | 130 | 60 | 60 | 0.46 | 0.07 | 5.33 |
| III ^{a)} | PDMAEMA | 5 | 64.8 | 34 | 60 | 60 | 0.17 | 0.03 | 5.33 |
| IV ^{b)} | PMMA | 15 | 84.5 | 104 | 60 | 240 | 0.23 | 0.03 | 5.33 |

^{a)} Polymerization was performed using ethanol as solvent;
^{b)} Polymerization was performed using toluene as solvent;
^{c)} Estimated by ¹H NMR, T = 70° C.

### Synthesis of Quasi-Block Copolymers.

The chain extension of macroCTA (I-III) precursors to obtain quasi-block copolymers PDMAEMA-qb-P (DMAEMA-co-[BVBI]Cl) was performed in a one-pot procedure as follows:

Right after the synthesis of the macroCTA, up to a certain conversion of DMAEMA (ca. 60%), the reaction mixture was cooled to room temperature; then, pre-defined amounts of [BVBI]Cl (considering the unreacted DMAEMA) and ACVA were added to this crude polymerization mixture (Table 6). Thereafter, this new reaction mixture was degassed and heated again to 70° C. to re-initiate the polymerization. Samples were withdrawn to follow conversion by ¹H NMR. Finally, quasi-block copolymers were purified by dialysis in deionized water (48 h, r.t., 1 kDa MWCO). The final product was freeze-dried for 24 h to obtain a yellowish solid.

TABLE 6
Experimental details and characterization of quasi-block copolymers
P[WₘYₙZₒCl] (PDMAEMA-qb-P(DMAEMA-co-[BVBI]Cl)).

| | Remnant DMAEMA | [BVBI]Cl | [BVBI]Cl | Conv [%] ^{a)} | | M_{n, exp} ^{c)} | |
|---|---|---|---|---|---|---|---|
| Entry | [mmol] ^{a)} | [mol %] ^{b)} | [mmol] | [BVBIM]Cl | DMAEMA | [kg mol⁻¹] | Ð ^{c)} |
| C6 | 16 | 20 | 3.2 | 99 | 70 | 8.68 | 1.20 |
| C7 | 21 | 20 | 4.2 | 99 | 58 | 13.5 | 1.30 |
| C8 | 18.1 | 20 | 3.6 | 99 | 74 | 5.72 | 1.15 |
| C9 | 18.1 | 40 | 7.2 | 99 | 83 | 5.85 | 1.15 |

^{a)} Estimated by ¹H NMR, T = 70° C.;
^{b)} Initial monomer mol feed ratio of [BVBI]Cl with respect to DMAEMA;
^{c)} determined by SEC in DMAc/LiCl (RI detection, PMMA calibration);
Synthesis of block copolymers PMMA-b-(P([BVBI]Cl-co-DMAEMA)).

Chain extension reactions for the synthesis of block copolymers were performed using PMMA (IV) as macroCTA. The experimental procedure was as follows:

The predetermined amounts of PMMA and DMSO were transferred to a round bottom flask and subjected to vigorous stirring for 2 h, at 45° C. Next, predetermined quantities of [BVBI]Cl, DMAEMA, initiator solution (ACVA in DMSO), and 1,3,5-trioxane were added to the flask (Table 7). The total reaction volume was 24.9 mL with an initial monomer concentration of 0.5 M. Thereafter, the flask was septum sealed, and the mixture was degassed by sparging N₂ gas for 30 min. This reaction mixture was heated for 12 h. Aliquots were withdrawn at 0, and 12 h to estimate monomer conversion by 1H NMR. Once the reaction time elapsed, the polymer was purified by dialysis in H₂O/ethanol (ratio=80/20, 48 h, r.t., 1 kDa MWCO) and subsequent freeze drying for 48 h.

TABLE 7
Experimental details for the synthesis of block copolymers
P[WₘYₙZₒCl] precursors (PMMA-b-P([BVBI]Cl-co-DMAEMA)).

| | Time | Conversion | [Monomer/ | Solvent | Monomer | MacroCTA | ACVA | Trioxane |
|---|---|---|---|---|---|---|---|---|
| Entry | [h] | [%] ^{a)} | macroCTA] | [mL] | [mmol] | [mmol] | [mmol] | [mmol] |
| C10 | 12 | 58 | 100 | 24.9 | 20.8 | 0.21 | 0.04 | 5.33 |

^{a)} Estimated by ¹H NMR; T = 85° C.

### Example 4—Preparation of Catalysts P[WₘYₙZₒM]

To conduct the anion exchange reactions of copolymers P[WₘYₙZₒCl] with Me_{q}Clᵣ salts in liquid phase, the copolymer and the corresponding salt were dissolved in ethanol. A representative example is as follows:

50 mg of copolymer P[WₘYₙZₒCl] were dissolved in 1 mL of ethanol. The mixture was then stirred until complete dissolution, and then degassed by sparging N₂ for 20 minutes. Next, the mixture was immersed in a preheated oil bath at 80° C. After heating the mixture for 30 minutes, anion exchange was performed by adding a solution of the corresponding salt (3.0 mg) in EtOH (0.1 g mL⁻¹). Heating and stirring continued for 12 h. After addition of the salt, a viscous precipitate was observed. The resulting heterogeneous mixture was purified by completing the precipitation of the polymer into acetone. Finally, the precipitate was washed three times with 10 mL of ethanol and 10 mL of acetone each to remove any residual reactants. The same procedure was followed to perform the anion exchange of homopolymers and copolymers. The final solid was dried until constant weight in a vacuum oven (at 40° C.). The ratio of metallic salt (R) was calculated according to Eq. 1:

$$R = \frac{{n}_{{ME}_{q} {Cl}_{r}}}{{n}_{{Me}_{q} {Cl}_{r}} + {n}_{[ BVSI ] Cl}} \qquad Eq . 1$$

where n_{Me}_{_{q}}_{Cl}_{ᵣ} represents moles of salt and n_{[BVSI]Cl} represents moles of the corresponding polymerized monomer [BVSI]Cl (estimated by 1H NMR). A representative series of anion exchanged P[WₘYₙZₒM] materials is listed in Table 8 along with their solubility properties in EG and aqueous mixtures.

TABLE 8
Solubility properties of representative P[WₘYₙZₒCl] and their
anion exchanged derivatives (P[WₘYₙZₒM]) in EG, H₂O, and mixtures thereof
(T = 25° C., c = 10 mg mL⁻¹). ^{a)}

| | | | | EG:H₂O ratio | | | | | | | |
|---|---|---|---|---|---|---|---|---|---|---|---|
| Entry | Copolymer | Me_{q}Clᵣ | R | 100:0 | 95:5 | 90:10 | 80:20 | 60:40 | 40:60 | 20:80 | 0:100 |
| A1 | — | — | — | S | S | S | S | S | S | S | S |
| M1 | A1 | ZnCl₂ | 0.75 | U | U | B | S | S | S | S | NS |
| M2 | A2 | ZnCl₂ | 0.75 | U | U | B | S | S | S | S | NS |
| M3 | A2 | ZnCl₂ | 0.5 | B | S | S | S | S | S | S | NS |
| M4 | A2 | ZnCl₂ | 0.25 | S | S | S | S | S | S | S | NS |
| M5 | A2 | ZnCl₂ | 0.1 | S | S | S | S | S | S | S | S |
| M6 | A2 | FeCl₃ | 0.7 | NS | NA | NA | NA | NA | NA | NA | NS |
| M7 | A2 | CoCl₂ | 0.7 | NS | NA | NA | NA | NA | NA | NA | NS |
| B2 | — | — | — | S | S | S | S | S | S | S | S |
| M8 | B2 | ZnCl₂ | 0.75 | U | U | B | S | S | S | S | NS |

^{a)} S: soluble; B: Tyndall effect; U: UCST-type phase separation; NS: non-soluble; NA: Not available

### Example 5—Characterization and Thermal Stability of P[WₘYₙZₒM] Catalysts

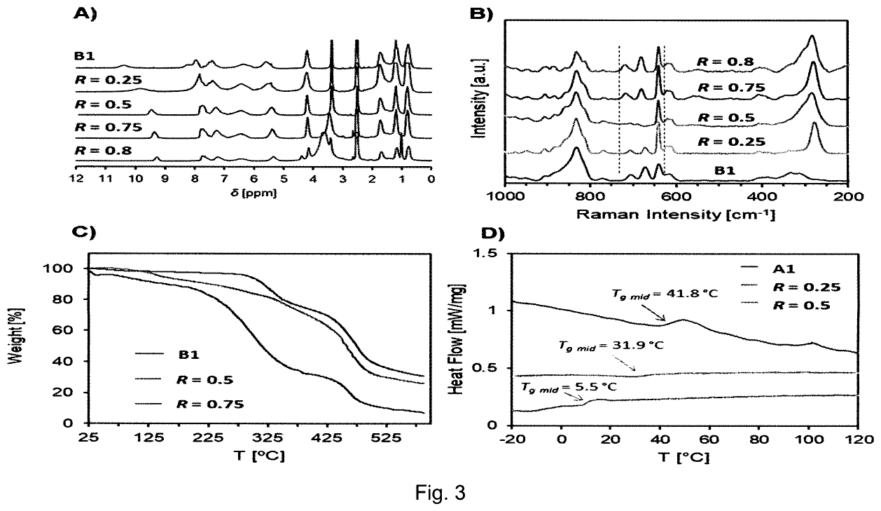

Depending on anion speciation, defined by the molar ratio (R) of Me_{q}Clᵣ in P[WₘYₙZₒM] materials, the generated polymers developed tunable physicochemical properties, for instance, thermal stability, solubility, and catalytic activity. In this example, 1H NMR, Raman spectroscopy and thermogravimetric analysis of model anion exchanged homopolymers P[WₘYₙZₒM] (chlorozincate homopolymers (P[WₘYₙZₒZn_{q}Clᵣ])) revealed the effect of anion speciation at different molar fractions of ZnCl₂ (FIG. 3). In all cases, a clear correlation to the molar ratio R was identified.

For instance, 1H NMR (FIG. 3A) shows an upfield shifting of the signals, suggesting the shielding of the protons provided by chlorozincate anions. The shifting of the signals was well correlated with the ratio of ZnCl₂. Raman spectroscopy (FIG. 3B) showed new signals in the range of 250-600 cm⁻¹, with respect to the reference P[WₘYₙZₒCl], suggesting the occurrence of chlorozincate anions. Likewise, the shift and emergence of new shoulder signals (400 to 500 cm⁻¹) confirmed the anionic speciation of chlorozincate anions through new symmetries (from [ZnCl₄]²⁻ to [Zn₂Cl₆]²⁻ to [Zn₄Cl₁₀]²⁻, etc.). These analyses demonstrated the occurrence of oligomers of variable symmetry between polymer chains within the structure of the polymer complex, which influences on the thermal stability, solubility, stimuli-responsive behavior in solutions, and catalytic activity of the corresponding P[WₘYₙZₒM].

FIG. 3C compares the results of thermogravimetric analysis (TGA) of P[WₘYₙZₒCl] (B1) and its corresponding series of chlorozincate P[WₘYₙZₒZn_{q}Clᵣ] derivatives. The reference curve of P[WₘYₙZₒCl] shows two major zones of mass loss:
1. The mass loss of the imidazole groups in the range of 200 to 350° C., and
2. The loss of the styrenic group around 400-500° C.

After anion exchange (R=0.25), the thermal stability of P[WₘYₙZₒZn_{q}Clᵣ] increased with the initial mass loss of the imidazole group, enhanced by approximately 50° C. The improved thermal stability exposes the effects of the shielding of the anionic species from the imidazole groups and the presence of a framework of anionic oligomers within the structure of the polymer system. In this regard, the larger area of the decomposition peak of the styrenic backbone further suggest that the polymer chains are interconnected by the oligomeric anions. Subsequently, for R=0.75, the thermal stability of P[WₘYₙZₒZn_{q}Clᵣ] increased up to ca. 320° C. Thus, these set of examples revealed the enhanced thermal stability of P[WₘYₙZₒZn_{q}Clᵣ], which corresponded well to the occurrence of an assortment of anions in the systems, as described in literature. The slight change of thermal stability observed between halometallate derivatives with different ratios of ZnCl₂, and the decreasing values of glass transition in DSC experiments (FIG. 3D), confirmed changes in the molecular mobility of polymer chains due to the presence of oligomeric species of counterions with variable structure. Thus, the amorphous state in the polymer systems was favored as the molar ratio of ZnCl₂ increased. Notably, the thermal stability of P[WₘYₙZₒZn_{q}Clᵣ] was disclosed; suggesting that such materials could be used as catalysts for the chemical recycling of PET without degradation (under typical glycolysis conditions, T=160 to 280° C.).

FIG. 3A) shows ¹H NMR Spectra, FIG. 3B) shows Raman spectra, and FIG. 3C) shows TGA curves of P[WₘYₙZₒCl] (B1) and its anion exchanged P[WₘYₙZₒZn_{q}Clᵣ] derivatives. FIG. 3D) shows DSC curves of P[WₘYₙZₒCl] (A1) and its anion exchanged P[WₘYₙZₒZₙClᵣ] derivatives.

### Example 6—Characterization of Solution Properties of Catalysts P[WₘYₙZₒM]

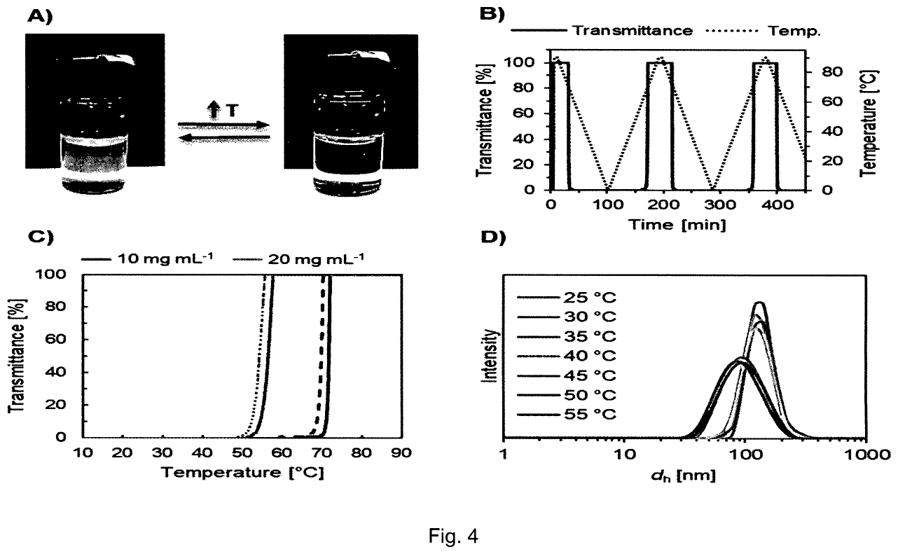

To obtain a better understanding of the phase separation behavior of the polymer catalysts during and after the (trans)esterification or depolymerization reactions, the series of P[WₘYₙZₒM] in Example 1 were further analyzed in solutions of EG, H₂O and mixtures thereof. Table 8 shows the solubility properties of catalysts prepared by anion exchange. P[WₘYₙZₒCl] copolymers were readily soluble in polar solvents. P[WₘYₙZₒM] catalysts were partially insoluble in EG and H₂O. Examples of P[WₘYₙZₒFe_{q}Clᵣ] and P[WₘYₙZₒCo_{q}Clᵣ] revealed null solubility in polar solvents. On the other hand, P[WₘYₙZₒZn_{q}Clᵣ] derivatives were insoluble in EG and H₂O at room temperature (entries M1 to M5 and M8, Table 8). After heating P[WₘYₙZₒZn_{q}Clᵣ] in EG solutions (Entry M2, R=0.75, Table 8), the polymer was solubilized to obtain a transparent solution at elevated temperature (ca. 90° C.). This solution became cloudy after returning to room temperature, showing a spontaneous and reversible Upper Critical Solution Temperature (UCST) behavior (FIG. 4A). FIG. 4B shows the thermo-responsive behavior of a representative solution of P[WₘYₙZₒZn_{q}Clᵣ] (M2 in EG, 20 mg mL⁻¹) by using turbidimetry experiments. The reversible UCST behavior was confirmed by measuring the transmittance of the solution in several heating and cooling cycles with a clear, spontaneous and reversible change of solubility of the polymer as a function of temperature.

The UCST behavior of P[WₘYₙZₒZn_{q}Clᵣ] could also be fine-tuned by multiple variables, such as the concentration of polymer, the molar mass and composition of (co) polymers, solvents, among others. FIG. 4C shows the effect of concentration on the thermo-responsive behavior of a solution of P[WₘYₙZₒZn_{q}Clᵣ] M2 in EG (10 to 20 mg mL⁻¹). The change of concentration promoted an increase in the T_{CP} of the solution from about 10° C. The effects of the molar mass were also investigated using the series of P[WₘYₙZₒZn_{q}Clᵣ] copolymers M1 to M4. Additional transmittance experiments of T_{CP} as a function of the degree of polymerization (DP) of P[WₘYₙZₒZn_{q}Clᵣ] in solution revealed that the thermo-responsive behavior is not entirely dependent on the molar mass of the polymer; specifically in a low molar mass range (DP=1 to 40). However, P[WₘYₙZₒZn_{q}Clᵣ] of higher DP values induced lower T_{CP} values, due to the higher concentration of Zn_{q}Clᵣ species and the strong dependence of the system on the formation of oligomeric ionic species in solution.

Table 8 (entries M2 to M5) summarizes the solution properties of P[WₘYₙZₒZn_{q}Clᵣ] derivatives, with different molar ratios of ZnCl₂ (R=0.1 to 0.75) in EG. P[WₘYₙZₒZn_{q}Clᵣ] systems with R=0.50 showed good solubility in EG, producing blue to transparent solutions; subsequent systems with lower values of R produced clear solutions (0.25, and 0.1); therefore, no T_{CP} was observed for this set of experiments by turbidimetry examinations. Following this trend, Dynamic Light Scattering (DLS) assays, using a Malvern apparatus (Zetasizer Nano ZS), showed that decreasing the molar ratio of anions to R=0.1 and 0.25 promoted the generation of several populations with variable hydrodinamic diameter (dₕ) and high PDI in EG solutions (dₕ=127.6, PDI=1.0 and 217.5 nm, PDI=0.579, respectively). Consequently, the value of R should be ≥0.5 (dₕ=94.8, PDI=0.207) or more preferred R≥0.75 (dₕ=129.0, PDI=0.052) to produce stable and well-defined nanoparticles populations in EG solutions under the examined conditions. Thus, DLS measurements of P[WₘYₙZₒZn_{y}Clₓ] in EG solutions with R=0.75 (M2, 10 mg mL⁻¹) revealed a monomodal distribution (FIG. 4D, 25° C.).

FIG. 4A) shows representative pictures of the thermo-responsive behavior of a solution of P[WₘYₙZₒZn_{q}Clᵣ] (M2) in EG (20 mg mL⁻¹).

FIG. 4B) shows temperature and transmittance curves of a solution of P[WₘYₙZₒZn_{q}Clᵣ] (M2) in EG (20 mg mL⁻¹) as a function of time.

FIG. 4C) shows turbidity measurements of P[WₘYₙZₒZn_{q}Clᵣ] (M2) in EG solutions (10 and 20 mg mL⁻¹); solid line: heating; dotted line: cooling.

FIG. 4D) shows plots of the dn (nm) as a function of temperature, recorded by DLS, of a solution of P[WₘYₙZₒZn_{q}Clᵣ] (M2) in EG (10 mg mL⁻¹).

DLS experiments with temperature gradients exposed the thermal behavior of the nanoparticles of P[WₘYₙZₒZn_{q}Clᵣ] in EG solutions. In a representative experiment, a solution of P[WₘYₙZₒZn_{q}Clᵣ] (M2, R=0.75, 10 mg mL 1) in EG was placed in the DLS setup, heated from 25 to 60° C. with changes of 5° C. per step, and measurements were recorded in each step (in triplicate, FIG. 4 D). As observed in FIG. 4D, at the onset temperature, species with an average dₕ of 129 nm are mostly present in the solution, as nanoparticles are present in solution (below the T_{CP}). Subsequent measurements disclosed the gradual decreasing of dₕ as the experiment reached the Top of the solution (recorded by the turbidimetry tests: 55° C.). Subsequently, when the solution became fully crystalline, the DLS measurement recorded the lowest value of dₕ (88.7 nm). Additionally, the recorded derived count rate indicated a decrease in value as the temperature increased in the examined range (40 to 60° C.); thus, after reaching the T_{CP} of the sample, there are fewer particles in solution. Likewise, the PDI increased as a function of the temperature, suggesting the presence of populations with a wider range of sizes because of the dissolution of nanoparticles in the system.

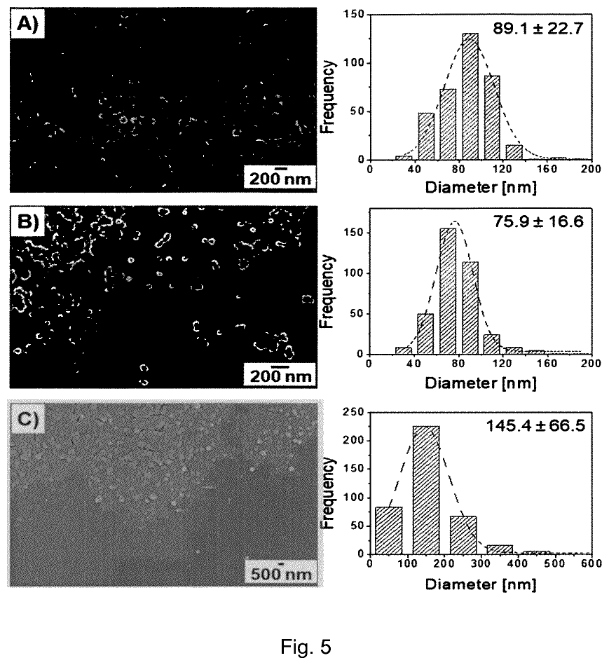

Scanning electron microscopy (SEM) analysis, using a Carl Zeiss apparatus (Sigma VP Field Emission, equipped with an Everhart-Thornley SE detector), of a representative sample of P[WₘYₙZₒZn_{q}Clᵣ] in glycol solutions (M2, R=0.75, 10 mg mL⁻¹) casted onto silicon wafers (FIG. 5), demonstrated the presence of spherically shaped particles with mean particle diameters from 70 nm to 150 nm as a function of the glycols utilized (EG, 1,3-propanediol, and glycerol). Thus, the formation of stable particles of P[WₘYₙZₒZn_{q}Clᵣ] in glycol solutions was confirmed.

FIG. 1 shows SEM images and particle size distributions of polymer nanoparticles casted at room temperature from solutions of M2 (10 mg mL⁻¹) in different glycol solvents: FIG. 5A) EG, FIG. 5B) glycerol, and FIG. 5C) 1,3-propanediol.

Copolymers comprising additional solvophilic compositions showed a similar solution behavior (Table 9). Furthermore, adding hydrophilic segments in the copolymers induced a gradual increase on the TCP of the corresponding solutions in EG. Representative transmittance experiments showed that a reference homopolymer P[WₘYₙZₒZn_{y}Clₓ] (M8, Table 8) showed a T_{CP} of approximately 58° C. This value decreased for copolymers with an increasing ratio of additional hydrophylic comonomer (DMAEMA, Table 4) with a variable T_{CP} of up to 16° C. ([BVBI]Cl:DMAEMA=0.42:0.58. Copolymers with greater compositions of PDMAEMA were also evaluated; however, although a thermal transition was visible, a sharp transition from cloudy to transparent solutions was not observed. Thus, the addition of hydrophilic segments of PDMAEMA conferred more solubility to the copolymers in glycol solutions.

As listed in Table 9, statistical P[WₘYₙZₒZn_{q}Clᵣ] copolymers also showed UCST behavior in EG solutions, even with a small fraction of H₂O in solution (M9, Table 9). Moreover, Table 9 also shows that modifying the structure of the copolymers also had a crucial effect on their solution properties. For instance, quasi-block copolymer precursors (entries C8 and C9) showed a sharp Low Critical Solution Temperature (LCST) behavior in aqueous solutions provided by adding thermo-responsive segments of PDMAEMA. However, the addition of EG to such copolymer mixtures increased the copolymer solubility, thus vanishing the T_{CP}; even at the lowest concentrations of EG evaluated in this study (EG:H₂O=20:80).

TABLE 9
Solubility properties of selected copolymers with variable structure and compositions
in EG, H₂O, and mixtures thereof (T = 25° C., c = 10 mg mL⁻¹). ^{a)}

| | | Composition [%] ^{c)} | | EG:H₂O ratio | | | | | | | |
|---|---|---|---|---|---|---|---|---|---|---|---|
| Entry | Coolymer/solvent ^{b)} | ([BVBI]Cl | DMAEMA | 100:0 | 95:5 | 90:10 | 80:20 | 60:40 | 40:60 | 20:80 | 0:100 |
| C3 | P([BVBI]Cl-co-DMAEMA) | 36.8 | 63.2 | S | S | S | S | S | S | S | S |
| M9 | P([BVBI]Zn_{q}Clᵣ-co-DMAEMA) | 36.8 | 63.2 | U | U | S | S | S | S | S | NS |
| C8 | PDMAEMA-qb-P([BVBI]Cl-co-DMAEMA) | 7.0 | 93.0 | S | S | S | S | S | S | S | L |
| M10 | PDMAEMA-qb-P([BVBI]Zn_{q}Clᵣ-co-DMAEMA) | 7.0 | 93.0 | B | B | B | S | NS | NS | NS | NS |
| C9 | PDMAEMA-qb-P([BVBI]Cl-co-DMAEMA) | 14.1 | 85.9 | S | S | S | S | S | S | S | L |
| M11 | PDMAEMA-qb-P([BVBI]Zn_{q}Clᵣ-co-DMAEMA) | 14.1 | 85.9 | U | B | B | B | NS | NS | NS | NS |

^{a)} S: soluble; I: insoluble; U: UCST-type phase separation; L: LCST-type phase separation; NS: non-soluble; 1 wt. % solutions;
^{b)} R = 0.75;
^{c)} determined by ¹H NMR in DMSO-d₆.

The solubility of the quasi-block copolymers was also modified after anion exchange; for instance, entries M10 and M11 revealed low to null solubility in aqueous solutions. Thus, the complexation effects (Zn—N) became more prominent for (co) polymers with a high content of PDMAEMA. Consequently, quasi-block copolymers only showed solubility for solutions with solvent ratios EG:H₂O greater than 80:20. For the latter examples, bluish solutions were observed and a clear UCST transition was only observed for EG solutions of the quasi-block copolymer with the highest composition of ionic sites (Table 9, Entry M11). The decreasing dₕ, PDI, and derived count rate measured by DLS (dₕ=136 nm and 65 nm, in solutions of EG:H₂O=100:0 and EG:H₂O=80:20, respectively) confirmed the increasing dissolution of the quasi-block copolymers by adding water to the solution.

Similarly to examples in FIG. 5, SEM images revealed the occurrence of spherical-shaped nanoparticles in EG solutions of quasi-block copolymers and M10 and M11 (Table 9) with homogeneous populations. The addition of hydrophilic sites in the (co) polymer system also supported the stabilization of nanoparticles with defined shape in EG solutions. As such, these examples demonstrated that copolymers can also be tailored with additional features of solubility, for instance LCST behavior, which as exemplified were useful to stabilize nanoparticles under the described conditions. The solution behavior of these (co) polymer systems revealed that, as a function of temperature, P[WₘYₙZₒZn_{q}Clᵣ] derivatives formed homogeneous solutions in glycols at elevated temperatures (above the T_{CP} of the solution) and cloudy dispersions below the T_{CP} of the solution. Well-defined and stabilized particles with nanometric size were observed under the described conditions. As shown in the following examples, such features benefit the catalytic performance and the capability to remove impurities from the polymer catalyst. Particularly, homopolymers and statistical copolymers along with chlorozincate anions are suitable polymer catalyst systems for the depolymerization of polyesters under glycolytic conditions.

### Example 7—Depolymerization Method

Depolymerization reactions were performed in a commercially available automated parallel synthesizer SWING XL FORMAX platform from Chemspeed Technologies AG (Switzerland). The platform was provided with a formulation module composed of six reactors (Volume=100 mL) that can be independently operated. Each reactor is provided with an individual feeding vessel, thermal jacket, thermocouple, mechanical stirring (anchor, disk, or disperser disc), and reflux condenser.

The reference depolymerization experiment consists of:
(i) transferring 31.5 g of EG into the reactors of the formulation block in the FORMAX platform;
(ii) charging each reactor vessel with the corresponding amount of polymer catalyst. The reference weight ratio of the catalyst is P[WₘYₙZₒZn_{q}Clᵣ]:PET=8.0 wt. %;
(iii) heating the reactors with a stirring speed of 500 rpm and within 30 minutes the reaction mixture reached the required temperature;
(iv) transferring the corresponding amount of post-consumer PET flakes (weight ratio PET:EG=1:4 wt. %) to start the reaction of depolymerization.

The concentration of the depolymerization product (BHET) was determined by 1H NMR using an internal reference (dimethyl sulfone (DS), DS:EG=0.01:1 wt. %). The PET conversion and BHET selectivity were also estimated gravimetrically by collecting the unreacted PET and purified BHET. Unreacted PET, solvophobic impurities and oligomers were collected, dried at 90° C. for 72 h, and weighed to estimate the PET conversion by Eq. 2:

$$Conversion of PET = \frac{{W}_{0} - {W}_{1}}{{W}_{0}} \times 100 \% \qquad Eq . 2$$

where W₀ represents the initial weight of PET and W₁ represents the weight of unreacted PET and oligomers. The isolated crystalline product was dried at 80° C. for 48 h and characterized as BHET. The selectivity of the monomer was estimated gravimetrically by Eq. 3:

$$Selectivity of BHET = \frac{{n}_{BHET}}{{n}_{f , PET}} \times 100 \% \qquad Eq . 3$$

where n_{BHET} represents the moles of BHET and n_{f,PET} represents the moles of depolymerized PET. The BHET obtained from different post-consumer PET feedstocks was characterized by DSC, TGA, FTIR and ¹H NMR.

### Example 8—Screening of P[WₘYₙZₒMe_{q}Clᵣ] with Variable Anions and Anion Concentration

The P[WₘYₙZₒCl] and P[WₘYₙZₒMe_{q}Clᵣ] derivatives were evaluated as catalysts in glycolysis reactions of post-consumer PET. The first series of depolymerization reactions were aimed at selecting the optimal anion for depolymerization. Thus, the catalytic performances of P[WₘYₙZₒMe_{q}Clᵣ] were tested as a function of the PET conversion and BHET selectivity.

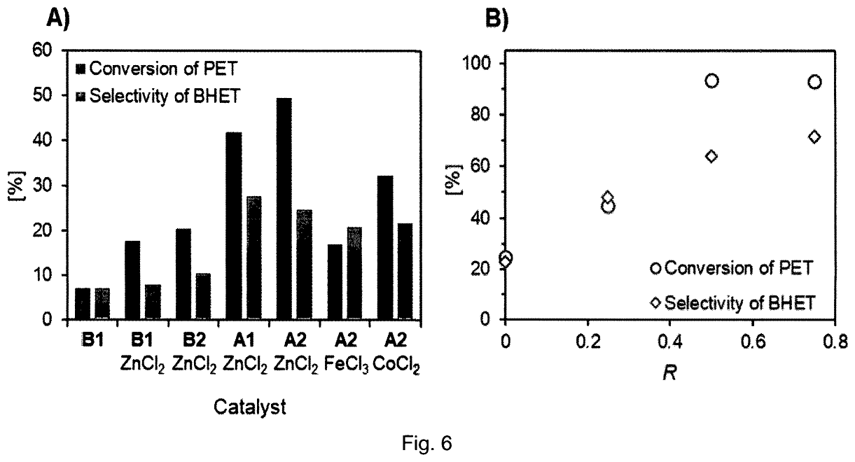

FIG. 6A shows the effect of P[WₘYₙZₒCl] and P[WₘYₙZₒMe_{q}Clᵣ] catalysts (precursors and metal chloride indicated, R=0.7) on PET glycolysis and selectivity of BHET. FIG. 6B) shows the effect of the molar ratio (R) of P[WₘYₙZₒZn_{q}Clᵣ] (M2 to M5, Table 8) on PET glycolysis and BHET selectivity.

FIG. 6A summarizes the depolymerization performance of P[WₘYₙZₒCl] copolymer (B1), which yielded low conversion and selectivity (<10%). P[WₘYₙZₒMe_{q}Clᵣ] derivatives yielded higher values of conversion and selectivity. Among these polymer catalysts, chlorozincate derivatives (P[WₘYₙZₒZn_{q}Clᵣ]) showed the best performance with up to 50% PET conversion and approximately 30% BHET selectivity. Examples of P[WₘYₙZₒFe_{q}Clᵣ] and P[WₘYₙZₒCo_{q}Clᵣ] also showed catalytic activity; however, for such cases, the PET conversion remained below the values obtained by using P[WₘYₙZₒZn_{q}Clᵣ] catalyst. This was attributed to the higher Lewis acidity of the voluminous chlorozincate anions and thermo-responsive behavior of chlorozincate derivatives, which considerably improved the interaction of catalytic sites and ester groups in PET chains, and consequently the yield and selectivity of BHET.

FIG. 6B shows the effect of the molar ratio (R) P[WₘYₙZₒZn_{q}Clᵣ] on the catalytic activity. The increasing molar ratio of ZnCl₂, and therefore Lewis acidity, aided the catalytic performance. Thus, it was confirmed that the increasing concentration of oligomeric chlorozincate anions assisted the catalytic activity of P[WₘYₙZₒZn_{q}Clᵣ] in glycolysis reactions. Furthermore, compared to preliminary results, the conditions used in this set of experiments (T=180° C., t=4 h, 500 rpm, FORMAX platform) increased the efficiency of the entire process to yield a PET conversion of up to 93% and BHET selectivity of 72%. Thus, the catalyzed depolymerization reaction using a robotic setup was also confirmed to be an efficient system for the screening of polymer catalysts.

### Example 9—Screening of P[WₘYₙZₒZn_{q}Clᵣ] with Variable Composition and Architecture

Copolymer derivatives, with variable composition of DMAEMA: [BVBI]Cl, were also tested with the depolymerization procedure described above. Table 10 shows that a maximum PET conversion (69%) was achieved by using P[WₘYₙZₒZn_{q}Clᵣ] with a molar ratio of DMAEMA:[BVBI]Cl=0.72:0.28 (Entry 1). This catalyst also showed the highest selectivity of BHET. Along with the copolymer with a ratio of 50:50 (Entry 2), such catalysts showed the highest efficiency and a proportional decrease in PET conversion as the content of [BVBI]Cl decreased in the composition.

P[WₘYₙZₒZn_{q}Clᵣ] with DMAEMA: [BVBI]Cl=40:60 and 26:74 ratio (Entry 3 and 4, respectively) also showed good catalytic activity in these experimental data. Compared to similar homopolymers examined in Example 8, the inclusion of hydrophilic PDMAEMA fractions increased the interactions between polyester chains and catalytic sites. These results also suggest that a lower content of catalytic sites could be used in the polymer catalyst system.

TABLE 10
Properties of the copolymer catalysts used in this study
and their performance in PET depolymerization.

| | | | Composition (%) ^{a)} | | Conversion | Selectivity |
|---|---|---|---|---|---|---|
| Entry | Precursor | P[WₘYₙZₒZn_{q}Clᵣ] | DMAEMA | [BVBI]Cl | of PET ^{b)} | of BHET ^{c)} |
| 1 | C1 | P([BVBI]Zn_{q}Clᵣ-co-DMAEMA) | 0.72 | 0.28 | 68.6 | 70.8 |
| 2 | C2 | P([BVBI]Zn_{q}Clᵣ-co-DMAEMA) | 0.50 | 0.50 | 61.0 | 70.7 |
| 3 | C3 | P([BVBI]Zn_{q}Clᵣ-co-DMAEMA) | 0.40 | 0.60 | 57.3 | 67.0 |
| 4 | C5 | P([BVBI]Zn_{q}Clᵣ-co-DMAEMA) | 0.26 | 0.74 | 42.8 | 64.2 |

^{a)} Determined by ¹H NMR in DMSO-d₆;
^{b)} determined by Eq. 2;
^{c)} Isolated selectivity determined by Eq. 3

Table 11 summarizes the catalytic activity of the block and quasi-block copolymers with a similar molar composition. The catalytic activity of the copolymers was evaluated using the automated parallel process described before. The depolymerization activity of quasi-block copolymers (entries 5 to 8), was similar to the results obtained by using homopolymers and statistical copolymers, with a PET conversion and BHET selectivity ranged as high as 90.9% and 68%, respectively. A slight decrease in catalytic activity was observed for entries 5 and 7, which was attributed to the low composition of catalytic sites in the polymer catalyst. Moreover, the steric and solubility effects of the polymer catalyst could reduce the interactions between catalytic sites and PET chains during the glycolysis reaction. This feature was enhanced by increasing the composition of catalytic sites in the polymer catalysts (see for instance entries 7 and 8); where a higher content of ionic sites improved the overall catalytic activity, regardless of the rest of the structure of the polymer catalyst. Additional examples with block copolymers, with sufficient content of ionic sites (Entry 9), also showed excellent catalytic performance. Thus, polymer catalysts could be further functionalized with different solvophilic or solvophobic segments, without affecting considerably their catalytic activity. As shown later, such additional properties of the polymer catalyst were advantageous according to the requirements of the depolymerization system.

TABLE 91
Properties of P[WₘYₙZₒZn_{q}Clᵣ] (quasi-block and block copolymers) used in this study and their performance in PET depolymerization

| | | | M_{n, theo} | Composition (%) ^{b)} | | | Conversion | Selectivity |
|---|---|---|---|---|---|---|---|---|
| Entry | Precursor | P[WₘYₙZₒZn_{q}Clᵣ] | [kg mol⁻¹] ^{a)} | [BVBI]Cl | DMAEMA | MMA | of PET ^{c)} | of BHET ^{d)} |
| 5 | C6 | PDMAEMA-qb-P([BVBI]Zn_{q}Clᵣ-co-DMAEMA) | 7.4 | 4.5 | 95.5 | — | 74.8 | 50.8 |
| 6 | C7 | PDMAEMA-qb-P([BVBI]Zn_{q}Clᵣ-co-DMAEMA) | 12.1 | 8.5 | 91.5 | — | 90.9 | 62.6 |
| 7 | C8 | PDMAEMA-qb-P([BVBI]Zn_{q}Clᵣ-co-DMAEMA) | 3.8 | 7.0 | 93.0 | — | 70.7 | 68.1 |
| 8 | C9 | PDMAEMA-qb-P([BVBI]Zn_{q}Clᵣ-co-DMAEMA) | 3.8 | 14.1 | 85.9 | — | 86.1 | 68.3 |
| 9 | C10 | PMMA-b-P([BVBI]Zn_{q}Clᵣ-co-DMAEMA) | 22.6 | 20.4 | 18.4 | 61.2 | 95.2 | 64.6 |

^{a)} Determined by the formula M_{n, theo} = {[([M_{[BVBI)Cl}]ₒ/[CTA]ₒ × Conv. × M_{[BVBI]Cl}] + [([M_{DMAEMA}]ₒ/[CTA]ₒ × Conv. × M_{DMAEMA}] + M_{n, CTA}};
^{b)} determined by ¹H NMR in DMSO-d₆;
^{c)} determined by Eq. 2;
^{d)} Isolated yield determined by Eq. 3

Hence, the examples provided showed the effective catalytic activity of the polymer catalysts disclosed herein. Among such P[WₘYₙZₒZn_{q}Clᵣ], homopolymers and statistical derivatives were found to show the best catalytic performance due to their Lewis acidity and stimuli-responsive behavior in solution. Thus, such P[WₘYₙZₒZn_{q}Clᵣ] were used as polymer catalysts to enhance the catalytic performance of the process due to the following remarks:
1. The synthesis procedure is simpler and more cost-effective;
2. The polymers are thermally stable under glycolysis conditions;
3. UCST behavior was observed for these (co) polymers, even with solutions with small fractions of H₂O;
4. In comparison with other anions, chlorozincate derivatives revealed higher catalytic activity PET glycolysis.

Therefore, the series of P[WₘYₙZₒZn_{q}Clᵣ] were used as catalyst capable of performing the homogeneous depolymerization reaction and the subsequent heterogeneous separation step to remove impurities and/or the same polymer catalyst.

### Example 10—Depolymerization of Post-Consumer PET with Different Coloration

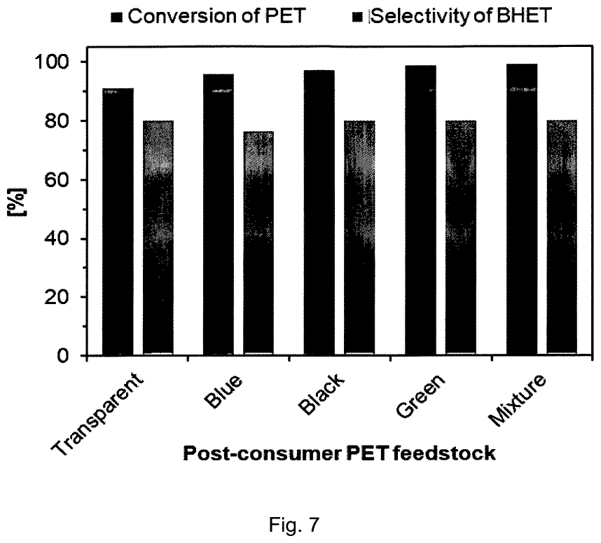

This study was performed to examine any variation of catalytic activity during the depolymerization reaction caused by additives or colorants; commonly added to food containers and soft drink bottles of PET. FIG. 7 shows the results of PET conversion and BHET selectivity by using different colors of PET flakes (transparent, blue, black, green, and a mixture thereof) as feedstock; statistical copolymer P[WₘYₙZₒZn_{q}Clᵣ] (M9, Table 9) was used as catalyst.

FIG. 7 shows the effect of the coloration of post-consumer PET on PET conversion and BHET selectivity using P[WₘYₙZₒZn_{q}Clᵣ] (M9, Table 9) as catalyst.

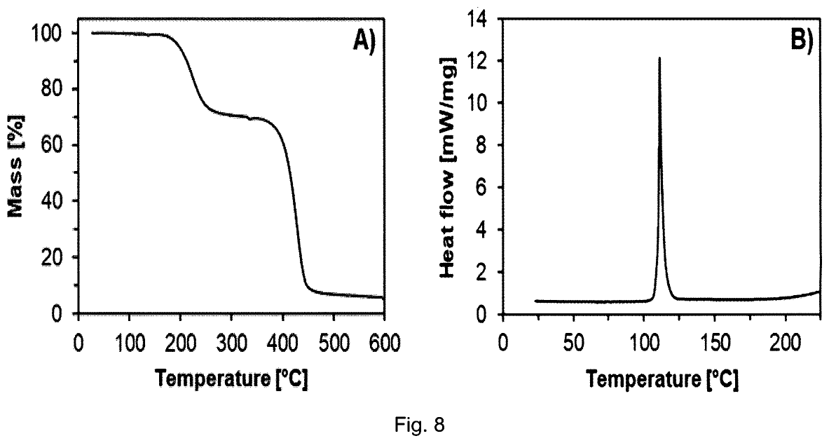

As observed, the PET conversion revealed values ranging from 95 to 99% and ca. 80% of BHET selectivity (isolated selectivity, determined by gravimetry). Compared to the experiment performed with transparent post-consumer PET, a similar catalytic performance was obtained with no regard of the post-consumer PET feedstock; thus, demonstrating the absence of any poisoning effect on the polymer catalysts. Thermal characterization techniques revealed the high purity of the final products obtained from the glycolysis of post-consumer PET with variable coloration. For instance, the TGA curves obtained product from a mixture of blue, black, green, and transparent PET feedstocks, displayed in FIG. 8A, shows the characteristic weight losses that correspond to the thermal decomposition of BHET. DSC curve of the corresponding product, displayed in FIG. 8B, show a sharp endothermic signal at 110° C. that corresponds to the reported melting point of BHET. These results discarded the presence of dimers and/or oligomers in the product, with melting points in the range of 173 to 220° C. Finally, the absence of remnant catalyst and/or zinc chloride salts or derivatives of the depolymerization mixture was corroborated by Elemental Analysis (Table 12).

FIG. 8 shows TGA (FIG. 8A) and DSC (FIG. 8B) curve of the BHET obtained from the glycolysis of a mixture composed of blue, black, green, and transparent post-consumer PET.

Table 12 summarizes the elemental analyses of different types of post-consumer PET and products of depolymerization. The C and H values of PET feedstocks (entries 1 and 2) and depolymerization product samples are in good accordance with the calculated values for the monomer BHET (entries 3 to 5). Likewise, the recorded N and Cl values of such samples confirm the absence of colorants and remnant catalyst in the product. Analysis of non-soluble impurities in water (Entry 6), which were removed from BHET by the addition of water to the crude mixture and subsequent filtration, confirmed the isolation of dimers after the depolymerization reaction. These findings strongly suggest the production and isolation of the monomer from depolymerization side products and polymer catalysts. Hence, it was concluded that BHET with high purity could be obtained by the catalytic system disclosed herein.

TABLE 12
Elemental Analyses of post-consumer PET used as raw materials and
BHET obtained from depolymerization reactions with P[WₘYₙZₒZn_{q}Clᵣ].

| | | | % C | % H | % N | % Cl |
|---|---|---|---|---|---|---|
| Entry | Compound | Starting PET | (Found/Calcd.) | (Found/Calcd.) | (Found/Calcd.) | (Found/Calcd.) |
| 1 | PET | Pink bottle | 62.5/62.57 | 4.2/4.3 | 0/0 | 0/0 |
| 2 | PET | Blue bottle | 62.5/62.61 | 4.2/4.31 | 0/0 | 0/0 |
| 3 | BHET | Black container | 56.7/56.85 | 5.60/5.60 | 0/0 | 0/0 |
| 4 | BHET | Mixture of PET | 56.7/56.85 | 5.60/5.60 | 0/0 | 0/0 |
| 5 | BHET | Mixture of PET | 56.7/56.69 | 5.60/5.56 | 0/0 | 0/0 |
| 6 | Residual dimers | Black container | 59.2/60.13 | 4.9/5.09 | 0.45/0 | 0/0 |

### Example 11—Removal of Impurities

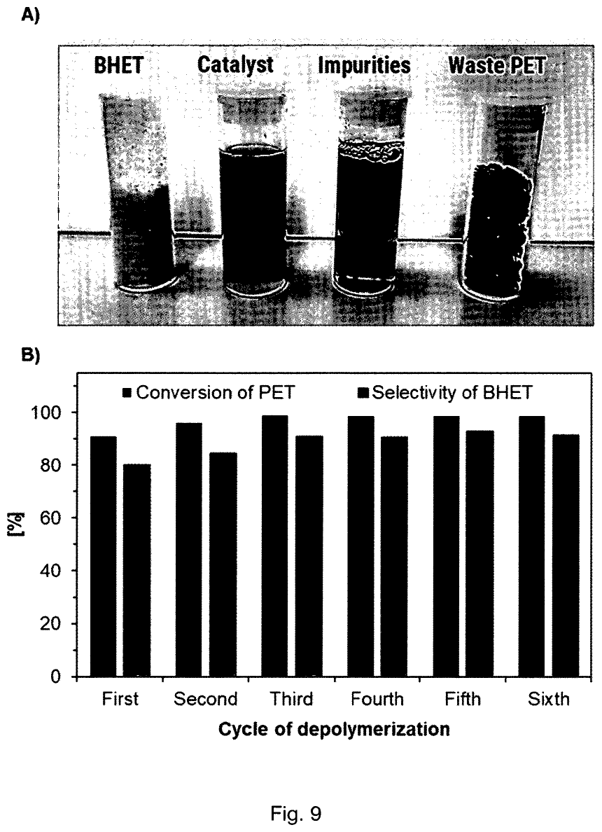

The crystalline product obtained from blue post-consumer PET From Example 10 showed a blue coloration due to the persistence of such colorant or dye in aqueous solutions, and therefore in the final product (BHET). To improve the purity of BHET obtained from blue-colored examples, a tailored depolymerization method was implemented using a specialized polymer catalyst. A P[WₘYₙZₒZn_{q}Clᵣ] composed of an additional solvophobic segment was used to assist the separation of colorants after the depolymerization reaction. This catalyst P[WₘYₙZₒZn Clᵣ] also yielded good catalytic performance (Entry 9, Table 11). Moreover, using such polymer catalyst, a white crystalline final product was obtained, which for the specific case of blue-colored post-consumer PET was difficult using other polymer catalysts (Example 10). Therefore, following the disclosed depolymerization procedure and P[WₘYₙZₒZn_{q}Clᵣ] catalyst, most remnant colorants remained in the polymer catalyst/EG/H₂O solution after isolating and crystallizing the final BHET monomer (FIG. 9A). The remnant mixture of polymer catalyst/EG/H₂O was concentrated by vacuum evaporation and washed with organic solvents to remove the colorants and produce a polymer catalyst/EG solution. This example showed that the purity of the recycled monomer could be further improved by modifying the structure and composition of the P[WₘYₙZₒZn_{q}Clᵣ] catalyst. These observations represent an advantage over earlier processes (see C. S. Nunes, P. R. Souza, A. R. Freitas, M. J. V. da Silva, F. A. Rosa and E. C. Muniz, Catalysts, 2017, 7, 1-16), which have shown a significant decrease in catalytic performance caused by the presence of colorants and/or impurities in post-consumer PET. Therefore, polymer catalysts with fine-tuned properties could be implemented for the depolymerization of specific post-consumer materials to overcome possible poisoning effects and enhance the purity of the final product.

FIG. 9A) shows images of the blue-colored post-consumer PET flakes used in Examples 11 and 12 and the products of depolymerization using P[WₘYₙZₒZn_{q}Clᵣ] (M9) as catalyst. BHET was obtained as a white crystalline solid (left). A yellowish polymer catalyst/EG solution was obtained after washing steps of hexane/diethyl ether (X3) to obtain an organic solution with the separated impurities/dyes/pigments. FIG. 9B) shows the reusability of the polymer catalyst in solution on the depolymerization of PET and selectivity of BHET.

### Example 12—Reusability of Polymer Catalyst

In a representative example, and in good agreement with the previous analysis of P[WₘYₙZₒZn_{q}Clᵣ] in solution (Example 6), the polymer catalyst/EG solution produce precipitates after keeping the solution at 4° C. Thus, suggesting that the P[WₘYₙZₒZn_{q}Clᵣ] remained in solution, preserving its UCST-type behavior after the depolymerization reaction. In this manner, the catalyst could be washed, in case of impurities, or isolated by filtration and/or ultracentrifugation at low temperatures.

Alternatively, the P[WₘYₙZₒZn_{q}Clᵣ]/EG solution was further used to perform new depolymerization cycles. For this purpose, a reactor vessel in the FORMAX platform was charged with the P[WₘYₙZₒZn_{q}Clᵣ]/EG solution. Subsequently, EG was added to reach a volume of 35 mL and a weight ratio of PET:EG=1:4 wt. %. Next, the reactor was heated and stirred at 500 rpm. After reaching a temperature of 180° C., the depolymerization was started by adding the corresponding amount of fresh post-consumer PET flakes. After the reaction time elapsed, the mixture was cooled down to 50° C. Then, 100 mL of deionized water (at 60° C.) were added to the final mixture to wash and remove the unreacted PET flakes, solvophobic impurities, and oligomers from the product. Then, the reaction mixture was filtrated and washed three times with an excess of water. The unreacted PET, solvophobic impurities, and oligomers were collected, dried at 120° C. for 72 h and weighed to estimate the PET conversion by Eq. 2. The collected aqueous solution was concentrated to ca. 100 ml by vacuum evaporation. The concentrated filtrate was stored at 4° C. for 24 h for crystallization. Then, white crystalline flakes formed in the filtrate. The isolated crystalline product was dried at 80° C. for 48 h and characterized as BHET. The selectivity of the monomer was estimated gravimetrically by Eq. 3. The remaining solution, containing P[WₘYₙZₒZn_{q}Clᵣ]/EG/H₂O, was concentrated by vacuum evaporation (at 55° C.) to remove water and yield the P[WₘYₙZₒZn_{q}Clᵣ]/EG solution. The reusability of the catalyst was further assessed using such solution as catalyst to perform up to six cycles of PET depolymerization as described before.

FIG. 9B summarizes the results for the depolymerization of PET by using a P[WₘYₙZₒZn_{q}Clᵣ]/EG solution in multiple depolymerization cycles (Sample M9, Table 9). As shown before, under the disclosed conditions of depolymerization, the first depolymerization cycle yielded excellent catalytic performance of about 90% PET conversion and about 80% BHET selectivity. Afterwards, using only the P[WₘYₙZₒZn_{q}Clᵣ]/EG solution, the second depolymerization cycle yielded a PET conversion of 96% and a BHET selectivity of 85%. Therefore, it was concluded that the P[WₘYₙZₒZn_{q}Clᵣ]/EG solution could be further used as catalyst in more cycles; avoiding additional washing and/or separation steps that could detriment the catalytic performance of the process.

As shown, the catalytic process was performed up to six cycles, exhibiting that the activity of the polymer catalyst remained nearly unaffected. Remarkably, in comparison with the first two cycles of depolymerization, the catalytic performance increased from the third cycle to the sixth cycle. In this trend, in the latter catalytic cycles, the PET conversion and BHET selectivity ranged as high as 99% and 92%, respectively.

Altogether, the disclosed invention provides the implementation of functional polymer catalysts for the (trans)esterification and depolymerization of post-consumer materials. The formation of ionic oligomeric species within the polymer structure promoted the UCST-type behavior of P[WₘYₙZₒZn_{q}Clᵣ] in glycol and aqueous solutions. This feature allowed the dissolution of the polymer in EG at temperatures above the T_{CP} of the solution. Therefore, during depolymerization reactions, the introduction of P[WₘYₙZₒZn_{q}Clᵣ] as catalysts yielded dispersed ionic species at elevated temperature to enhance the catalytic activity of the system. After the depolymerization reaction, the soluble P[WₘYₙZₒZn_{q}Clᵣ] could be spontaneously precipitated from the EG solution by decreasing the temperature for isolation, cleaning, or reuse of the catalyst for the next reaction cycle. Under optimized conditions, the polymer catalyst is easily recyclable in solution, which yielded over 90% BHET selectivity and displayed increasing catalytic activity after several depolymerization reactions. Consequently, the catalysts and methodologies provided in this disclosure can be used to construct a system of homogeneous catalytic reaction and heterogeneous separation of catalyst. The advantages of the polymer catalysts disclosed herein represent highly desirable features in chemical industry, as polymer catalysts could be designed and handled on demand; according to a specific process and/or feedstocks (e.g., different types or colorations of post-consumer materials). In this trend, it is demonstrated that the design of tailored copolymers, via copolymerization with additional monomers and/or variable architectures, added specialized functionalities to polymer catalysts for highly specific recycling processes (e.g., removal of impurities or dyes/pigments, improved separability, among others).

1. A composition comprising
A) at least one (poly)ester or (poly)amide or combinations thereof, and
B) at least one polymer comprising a structural unit of formula (I)
—(CH₂—CR³Z)ₒ— (I)
wherein
o is a positive integer of at least 1,
R³ is selected from the group of hydrogen, halogen, C₁-C₁₈ alkyl or C₁-C₁₈ alkyl substituted with one or more substituents independently selected from the group of hydroxy, carboxy, acyloxy, OR′, O₂CR′, and CO₂R′,
R′ is selected from the group of optionally substituted C₁-C₁₈ alkyl, optionally substituted C₂-C₁₈ alkenyl, optionally substituted aryl, substituted heterocyclyl, optionally substituted aralkyl, optionally substituted alkaryl, wherein said optional substituents are selected from the group consisting of epoxy, alkoxycarbonyl, aryloxycarbonyl, isocyanato, cyano, silyl, halo and dialkylamino,
Z is a group -BG-Cat⁺ M,
BG is a covalent bond or a divalent bridge group,
Cat⁺ is a one-time positively charged cationic residue selected from the group of one-time positively charged heterocyclic residues having one, two or three ring nitrogen atoms and optionally one ring oxygen atom, one ring sulfur atom, one ring phosphorus atom, one ring arsenic atom or one ring antimony atom, ammonium cations, phosphonium cations, arsonium cations or antimonium cations covalently attached to BG,
M is a negatively i-charged counter-ion of type Anⁱ⁻ which is selected from the group of organic or inorganic anions, wherein Anⁱ⁻ will interact with one or more cationic residues Cat⁺ for charge-compensation in polymer B), and
i is an integer from 1 to 4.

2. The composition according to claim 1, wherein component A) is a solid polyester or polyamide which is provided in a carrier liquid C) that is a suitable solvent for the monomer(s) resulting from degradation of said polyester or polyamide.

3. The composition according to claim 1, wherein component A) is a (poly)ester.

4. The composition according to claim 3, wherein the polyester is a poly carboxylic ester which is selected from polyethylene terephthalate (PET), polyethylene furanoate (PEF), polybutylene terephthalate (PBT), polytrimethylene terephthalate (PTT), polyglycolic acid (PGA), polylactic acid (PLA), polycaprolactone (PCL), polyethylene adipate (PEA), polyhydroxyalkanoate (PHA), polyhydroxy-butyrate (PHB), polyethylene naphthalate (PEN), Poly(3-hydroxybutyrate-co-3-hydroxyvalerate) (PHBV), and a polycondensate of 4-hydroxybenzoic acid and 6-hydroxynaphthalene-2-carboxylic acid (VECTRAN).

5. The composition according to claim 1, wherein component B) is a copolymer comprising recurring units of formulae (I) and (II) and optionally (III),
—(CH₂—CR¹W)ₘ— (II)
—(CH₂—CR²Y)ₙ— (III)
wherein formula (I) is as defined in claim 1,
m and n independently of one another are positive integers of at least 1,
R¹ and R² independently of one another are selected from the group of hydrogen, halogen, C₁-C₁₈ alkyl or C₁-C₁₈ alkyl substituted with one or more substituents independently selected from the group of hydroxy, carboxy, acyloxy, OR′, O₂CR′, and CO₂R′,
W and Y independently or one another are selected from the group of hydrogen, halogen, C₁-C₁₈ alkyl, cycloalkyl, alkoxy, alkylamino, and aryl, CO₂H, CO₂R′, COR′, CN, CONH₂, CONHR′, CONR′₂, O₂CR′ and OR′.

6. The composition according to claim 5, wherein component B) is a block-copolymer or a quasi-block copolymer comprising at least one block of recurring units of formula (II) and at least one block of recurring units of formula (IIIa)
[—(CH₂—CR¹W—)ₘ] (II),
[—(CH₂—CR²Y—)ₙ . . . —(CH₂—CR³Z—)ₒ] (IIIa),
wherein the two recurring units in formula (IIIa) are arranged in a statistical manner or in the form of blocks.

7. The composition according to claim 1, wherein BG is a covalent bond, an alkylene group of 1-10 carbon atoms, a phenylene group, an aralkylene group —C₆H₄—(CH₂)ₚ—, wherein p is an integer between 1 and 100, or groups selected from —COO—(CH₂)ₜ— or —CONH—(CH₂)ₜ—, wherein t is an integer from 1 to 100, and the carbon atom in the —COO— group or in the —CH—NH— group is attached to the polymer backbone and one carbon atom in the —(CH₂)ₚ— group is attached to Cat⁺.

8. The composition according to claim 1, wherein Cat⁺ is selected from monovalent quaternary ammonium residues, monovalent quaternary phosphonium residues, one-times positively charged monovalent heterocyclic groups with one to three ring nitrogen atoms and optionally one oxygen or one sulfur ring atom, said heterocyclic groups having 5 or 6 ring atoms.

9. The composition according to claim 8, wherein Cat⁺ is selected from pyrimidine, imidazole, piperidine, pyrrolidine, pyridine, pyrazol, oxazol, triazol, thiazol, methimazol, benzotriazol, isoquinol and viologen-type compounds.

10. The composition according to claim 1, wherein the anions Anⁱ⁻ are selected from the group consisting of BRF₃⁻, BRR′F₂⁻, BR₄⁻, CF₃SO₃⁻, CF₃CO₂⁻, HCO₂⁻, RCO₂⁻, RNH₂CO₂⁻, N(CF₃SO₂)₂⁻, N(RSO₂)₂⁻, N(CF₂S₂O₄)⁻, RSO₃⁻, and RR′PO₄⁻, wherein R and R′ are independently selected from the group consisting of alkyl, alkenyl, alkynyl, haloalkyl, alkoxyalkyl, cycloalkyl, cycloalkylalkyl, aryl, aralkyl, heterocyclyl, heterocyclylalkyl, heteroaryl, and heteroarylalkyl.

11. The composition according to claim 1, wherein the anions Anⁱ⁻ are selected from anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4.

12. The composition according to claim 11, wherein the anions Anⁱ⁻ are selected from the group consisting of [ZnCl₄]²⁻, [Zn₂Cl₆]²⁻, [Zn₃Cl₈]²⁻, [Zn₄Cl₁₀]²⁻, [FeCl₄]⁻, [FeCl₄]²⁻, [Fe₂Cl₇]⁻, [CoCl₄]²⁻, [CoCl₂ (CoCl₄)₂]⁴⁻, [CoCl₂(Co₂Cl₄)₃]⁴⁻ and the any mixtures thereof.

13. The composition according to claim 1, wherein the catalyst B) is a polymer or a copolymer comprising structural units of one or more of the formulae listed below: 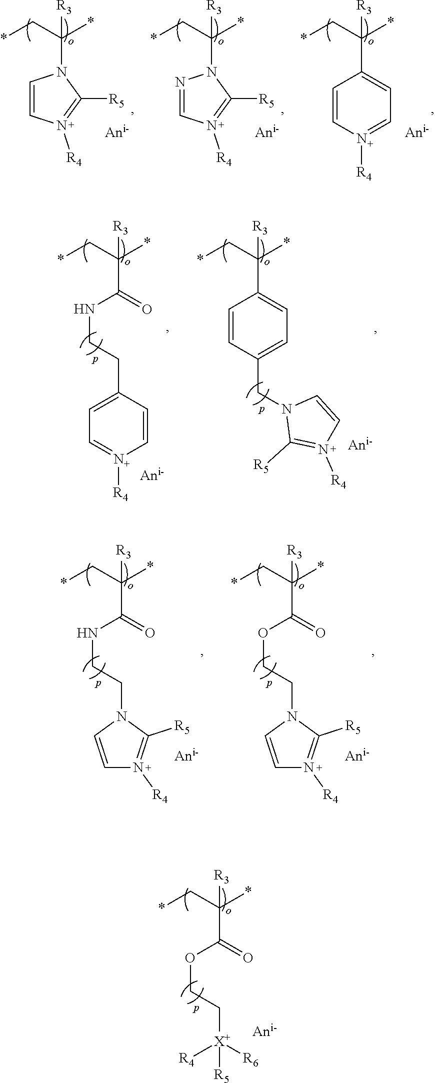
wherein
p is an integer and ranges from 1 to 100,
R₃, R₄, R₅ and R₆ are independently selected from the group of hydrogen, halogen, C₁-C₁₈ alkyl optionally substituted with one or more substituents independently selected from the group of hydroxy, carboxy, acyloxy, OR′, O₂CR′, and CO₂R′, optionally substituted aryl, optionally substituted heterocyclic rings, optionally substituted aralkyl, optionally substituted alkaryl; optionally substituted alkylthio, optionally substituted arylthiol, optionally substituted alkoxy, wherein said optional substituents are selected from the group consisting of epoxy, alkoxycarbonyl, aryloxycarbonyl, isocyanato, cyano, silyl, halo and dialkylamino,
X is selected from the group of N, P, As or Sb, and
wherein the anions Anⁱ⁻ are selected from anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4.

14. A polymer comprising structural units of formula (I) as defined in claim 1, wherein the anions Anⁱ⁻ are selected from anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4.

15. The polymer according to claim 14, comprising structural units of formula (II) and optionally of formula (III)
—(CH₂—CR²Y)ₙ— (III).

16. The polymer according to claim 14, wherein the polymer comprises structural units of one or more of the formulae listed below: 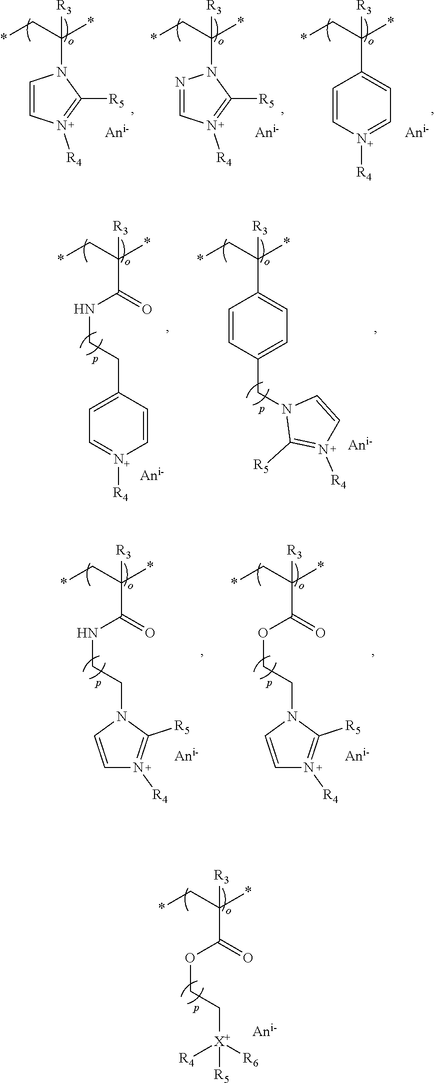
wherein
p is an integer and ranges from 1 to 100,
R₃, R₄, R₅ and R₆ are independently selected from the group of hydrogen, halogen, C₁-C₁₈ alkyl optionally substituted with one or more substituents independently selected from the group of hydroxy, carboxy, acyloxy, OR′, O₂CR′, and CO₂R′, optionally substituted aryl, optionally substituted heterocyclic rings, optionally substituted aralkyl, optionally substituted alkaryl; optionally substituted alkylthio, optionally substituted arylthiol, optionally substituted alkoxy, wherein said optional substituents are selected from the group consisting of epoxy, alkoxycarbonyl, aryloxycarbonyl, isocyanato, cyano, silyl, halo and dialkylamino,
X is selected from the group of N, P, As or Sb, and
wherein the anions Anⁱ⁻ are selected from anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4.

17. A method of degrading a polymer material A) chosen from the group of polyesters and/or polyamides in a degradation reaction catalyzed by a catalyst B) according to claim 1 in a carrier liquid C), the method comprising:
i) providing the polymer A) to be degraded, the catalyst B) and the carrier liquid C),
ii) mixing catalyst B), polymer A) to be degraded, and carrier liquid C);
iii) carrying out the degradation reaction to obtain a mixture comprising monomers, oligomers, carrier liquid C) and catalyst B),
iv) adding a polar medium, particularly water or an aqueous solution of aliphatic alcohol, to the mixture from step iii), to obtain a first hydrophilic phase comprising monomers and catalyst B) and a second hydrophobic phase comprising oligomers, and
v) separating the first hydrophilic phase from the second hydrophobic phase.

18. The method for degrading a polymer material according to claim 17 comprising:
i) providing the polyester and/or polyamide A) to be depolymerized and the catalyst B),
ii) mixing polyester and/or polyamide A) to be depolymerized, catalyst B) and a suitable solvent or mixture of solvents C),
iii) performing the depolymerization reaction by heating the mixture obtained in step ii) to obtain a homogeneous mixture of monomers, oligomers, impurities, catalyst and solvent,
iv) optionally cooling the mixture obtained in step iii),
v) adding a polar medium, particularly water or an aqueous alcoholic solution, to the mixture, to obtain a two-phase dispersion with a first solvophilic phase comprising depolymerization products and catalyst B) and with a second solovophobic phase comprising oligomers and impurities,
vi) separating the first phase from the second phase, preferably by filtration, decantation, or the like techniques,
vii) separating the main depolymerization product from the first solvophilic phase by crystallization followed by separation of the crystalline phase, preferably by filtration, decantation, or the like techniques,
viii) separating the catalyst B) from the first solvophilic phase by applying an external stimulus, particularly temperature, followed by removal of catalyst B), preferably by filtration, decantation, centrifugation, or the like techniques to recover catalyst B) from the solution, or, alternatively, re-using the first solvophilic phase containing catalyst B) or re-using the first solovophilic phase to which an additional amount of catalyst B) has been added to perform additional depolymerization reactions.

19. A method for transesterification or transamidation of (poly)esters or (poly)amides comprising:
i) Providing a (poly)ester and/or (poly)amide A) to be transesterified or transamidated, the catalyst B) of claim 1, an alcohol and/or an amine D),
ii) mixing the polyester and/or polyamide A), the catalyst B), the alcohol and/or the amine D), and optionally a suitable solvent or mixture of solvents C),
iii) performing the transesterification or transamidation reaction by heating the mixture obtained in step ii) to obtain a homogeneous mixture of monomers, oligomers, impurities, catalyst and solvent,
iv) optionally cooling the mixture obtained in step iii),
v) adding a polar medium, particularly water or an aqueous alcoholic solution, to the mixture, to obtain a two-phase dispersion with a first solvophilic phase comprising transesterification or transamidation products and catalyst B) and with a second solovophobic phase comprising oligomers and impurities,
vi) separating the first phase from the second phase, preferably by filtration, decantation, or the like techniques,
vii) separating the main transesterification or transamidation product from the first solvophilic phase by crystallization followed by separation of the crystalline phase, preferably by filtration, decantation, or the like techniques,
viii) separating the catalyst B) from the first solvophilic phase by applying an external stimulus, particularly temperature, followed by removal of catalyst B), preferably by filtration, decantation, centrifugation, or the like techniques to recover catalyst B) from the solution, or, alternatively, re-using the first solvophilic phase containing catalyst B) or re-using the first solovophilic phase to which an additional amount of catalyst B) has been added to perform additional transesterification or transamidation reactions.

20. A method of catalyzing a reaction comprising: using the compound B) of claim 1 as a catalyst in a depolymeriziation of polyesters or polyamides, or in a (trans)esterification reaction or in a (trans)amidation reaction.

21. The method according to claim 20, wherein the compound B) comprising structural units of formula (I) and (II) and optionally (III),
—(CH₂—CR¹W)ₘ— (II)
—(CH₂—CR²Y)ₙ— (III)
m and n independently of one another are positive integers of at least 1,
R¹ and R² independently of one another are selected from the group of hydrogen, halogen, C₁-C₁₈ alkyl or C₁-C₁₈ alkyl substituted with one or more substituents independently selected from the group of hydroxy, carboxy, acyloxy, OR′, O₂CR′, and CO₂R′.

22. The method according to claim 21, wherein the compound B) is a copolymer comprising Anⁱ⁻, the anions Anⁱ⁻ are selected from anions having the formula [Me_{q}Halᵣ]ⁱ⁻, in which Me is selected from the group consisting of B, P, As, Sb, Al, Au, Nb, Cd, Cu, Mn, Fe, Ga, Hf, Co, Ni, Ga, Pb, Sn, Ti, Zn and Zr, preferably selected from the group consisting of Zn, Fe and Co, Hal is a halogen atom, preferably selected from Fluoride, Chloride and Bromide, q is an integer between 1 and 6, r is an integer between 3 and 14, and i is an integer between 1 and 4.
